(19) United States
(12) Patent Application Publication
(10) Pub. No.: US 2025/0196501 A1
(43) Pub. Date: Jun. 19, 2025

(54) HEAD UNIT AND INK JET RECORDING DEVICE

(71) Applicant: FUJIFILM Corporation, Tokyo (JP)

(72) Inventor: Baku NISHIKAWA, Kanagawa (JP)

(73) Assignee: FUJIFILM Corporation, Tokyo (JP)

(21) Appl. No.: 18/967,543

(22) Filed: Dec. 3, 2024

(30) Foreign Application Priority Data
Dec. 19, 2023 (JP) 2023-213643

(51) Int. Cl. B41J 2/165

(52) U.S. Cl. CPC B41J 2/16511

(57) ABSTRACT

Provided are a head unit and an ink jet recording device having a compact configuration including a cap mechanism. A head unit includes a recording head that has a nozzle surface on which a plurality of nozzles are disposed and is movable between a first position and a second position; a cap that is provided on the recording head and is movable between a third position that covers the nozzle surface and a fourth position that opens the nozzle surface; and an interlocking mechanism that moves the cap from the third position to the fourth position by an operation of moving the recording head from the first position to the second position and moves the cap from the fourth position to the third position by an operation of moving the recording head from the second position to the first position.

### CROSS-REFERENCE TO RELATED APPLICATION

The present application claims priority under 35 U.S.C § 119 (a) to Japanese Patent Application No. 2023-213643 filed on Dec. 19, 2023, which is hereby expressly incorporated by reference, in its entirety, into the present application.

### BACKGROUND OF THE INVENTION

### 1. Field of the Invention

The present invention relates to a head unit and an ink jet recording device, and particularly to a head unit and an ink jet recording device comprising a cap mechanism.

### 2. Description of the Related Art

In the ink jet recording device, a representative defect phenomenon of the recording head that causes an image quality defect is a change in the non-jetting and jetting states (jetting direction defect, change in jetting amount, change in jetting speed, and the like). In a case where the non-jetting or jetting state of the specific nozzle changes, streaks appear in the image to be recorded.

The main factors causing the malfunction of the recording head are adhesion of foreign substances to the nozzle surface, solidification of ink, thickening, and the like. A cap mechanism is known as one of means for suppressing these. The cap mechanism covers the nozzle surface with the cap in a case of not being used, thereby suppressing the evaporation of the solvent from the nozzle, the adhesion of foreign substances to the nozzle surface, and the like.

In general, the cap mechanism is provided in a maintenance area different from a position where the recording operation of the image is performed. Therefore, in a case of capping, it is necessary to move the recording head to the maintenance area.

JP2005-305972A and JP2011-212949A describe a technique of providing a cap mechanism on a recording head to eliminate the need for moving the recording head to a maintenance position.

### SUMMARY OF THE INVENTION

However, the techniques disclosed in JP2005-305972A and JP2011-212949A have a disadvantage in that power is required to open and close the cap and the recording head is large.

The present invention has been made in view of such circumstances, and an object of the present invention is to provide a head unit and an ink jet recording device having a compact configuration including a cap mechanism.

(1) A head unit comprising: a recording head that has a nozzle surface on which a plurality of nozzles are disposed and is movable between a first position and a second position; a cap that is provided on the recording head and is movable between a third position that covers the nozzle surface and a fourth position that opens the nozzle surface; and an interlocking mechanism that moves the cap from the third position to the fourth position by an operation of moving the recording head from the first position to the second position and moves the cap from the fourth position to the third position by an operation of moving the recording head from the second position to the first position.

(2) The head unit according to (1), in which the recording head moves between the first position and the second position by linear motion, the cap moves between the third position and the fourth position by arc motion, and the interlocking mechanism converts the linear motion of the recording head into the arc motion of the cap.

(3) The head unit according to (2), in which the interlocking mechanism includes a biasing member that biases the cap toward the fourth position, and an engaging member that engages with the cap at a constant position with respect to the recording head that moves from the second position to the first position and moves the cap from the fourth position to the third position against a biasing force of the biasing member.

(4) The head unit according to (2), in which the interlocking mechanism includes a biasing member that biases the cap toward the third position, and an engaging member that engages with the cap at a constant position with respect to the recording head that moves from the first position to the second position and moves the cap from the third position to the fourth position against a biasing force of the biasing member.

(5) The head unit according to (2), in which the interlocking mechanism is configured by a combination of gears including a rack and a pinion.

(6) The head unit according to (2), in which the interlocking mechanism is configured by a cam mechanism or a link mechanism that converts linear motion into arc motion.

(7) The head unit according to any one of (1) to (6), in which the cap has a hollow shape that is open, and an opening portion is disposed to face the nozzle surface at the third position.

(8) The head unit according to (7), further comprising a sealing member that is provided on the recording head or the cap and that seals a periphery of the opening portion between the cap and the recording head positioned at the third position.

(9) The head unit according to (8), further comprising a locking mechanism that locks the cap positioned at the third position.

(10) The head unit according to (9), in which the locking mechanism is configured by a push latch mechanism.

(11) The head unit according to any one of (7) to (10), in which the cap includes a liquid absorbing body inside.

(12) The head unit according to any one of (7) to (11), in which the cap includes a dam portion that dam a liquid stored inside the cap from flowing out of the opening portion in a case where the cap is tilted.

(13) The head unit according to (12), in which the cap is divided into two parts in a depth direction by the dam portion, a liquid for moisturizing is stored in a space on a side of a bottom portion with the dam portion interposed therebetween, and a liquid jetted or discharged from the nozzle in a space on a side of the opening portion with the dam portion interposed therebetween is recovered.

(14) The head unit according to any one of (1) to (13), in which the cap moves between the third position and the fourth position by arc motion about an axis parallel to an arrangement direction of the nozzle, and in a cross section orthogonal to the axis, a portion of the cap closest to the axis is an edge portion of the cap.

(15) The head unit according to any one of (1) to (14), further comprising a driving unit that moves the recording head between the first position and the second position.

(16) An ink jet recording device comprising: a transport unit that transports a medium; and the head unit according to any one of (1) to (15) that records an image on the medium by jetting an ink from the nozzle toward the medium transported by the transport unit.

(17) The ink jet recording device according to (16), in which the head unit records the image on the medium in a single pass.

According to the present invention, it is possible to provide a head unit and an ink jet recording device having a compact configuration including a cap mechanism.

### BRIEF DESCRIPTION OF THE DRAWINGS

FIG. 1 is a side view showing a schematic configuration of an ink jet printer.

FIG. 2 is a plan view showing a schematic configuration of the ink jet printer.

FIG. 3 is a front view of a print head unit.

FIG. 4 is a side view of the print head unit.

FIG. 5 is a diagram showing a schematic configuration of a nozzle surface.

FIG. 6 is an enlarged view of a part of the nozzle surface.

FIG. 7 is a side view showing a configuration of a cap opening and closing mechanism.

FIG. 8 is a front view showing a configuration of the cap opening and closing mechanism.

FIGS. 9A and 9B are diagrams showing an elevating operation of a print head.

FIGS. 10A to 10C are diagrams showing a change in a state of a cap due to elevating of the print head.

FIG. 11 is a diagram showing a first modification example of the cap opening and closing mechanism.

FIGS. 12A to 12C are diagrams showing a change in a state of the cap due to elevating of the print head.

FIG. 13 is a diagram showing a second modification example of the cap opening and closing mechanism.

FIGS. 14A to 14C are diagrams showing a change in a state of the cap due to elevating of the print head.

FIG. 15 is a diagram showing a third modification example of the cap opening and closing mechanism.

FIGS. 16A to 16C are diagrams showing a change in a state of the cap due to elevating of the print head.

FIG. 17 is a diagram showing a fourth modification example of the cap opening and closing mechanism.

FIGS. 18A to 18C are diagrams showing a change in a state of the cap due to elevating of the print head.

FIG. 19 is a diagram showing a first modification example of the cap.

FIG. 20 is a diagram showing a second modification example of the cap.

FIGS. 21A to 21C are diagrams showing a change in a state of a moisturizing liquid due to swinging of the cap.

FIGS. 22A and 22B are diagrams showing a third modification example of the cap.

FIG. 23 is a diagram showing a configuration of a main portion of the print head unit.

FIG. 24 is a diagram showing a configuration of a main portion of the print head unit.

FIG. 25 is a diagram showing a configuration of a main portion of a third embodiment of the print head unit.

FIGS. 26A and 26B are explanatory views of locking and unlocking operations of the cap using a push latch mechanism.

FIG. 27 is a diagram showing another example of a movement form of the cap.

### DESCRIPTION OF THE PREFERRED EMBODIMENTS

Hereinafter, a preferred embodiment of the present invention will be described in accordance with the accompanying drawings.

### First Embodiment

Here, a case where the present invention is applied to an ink jet printer that prints a desired image on sheet paper in a single pass (1 pass) will be described as an example. The ink jet printer is an example of an ink jet recording device.

### Ink Jet Printer

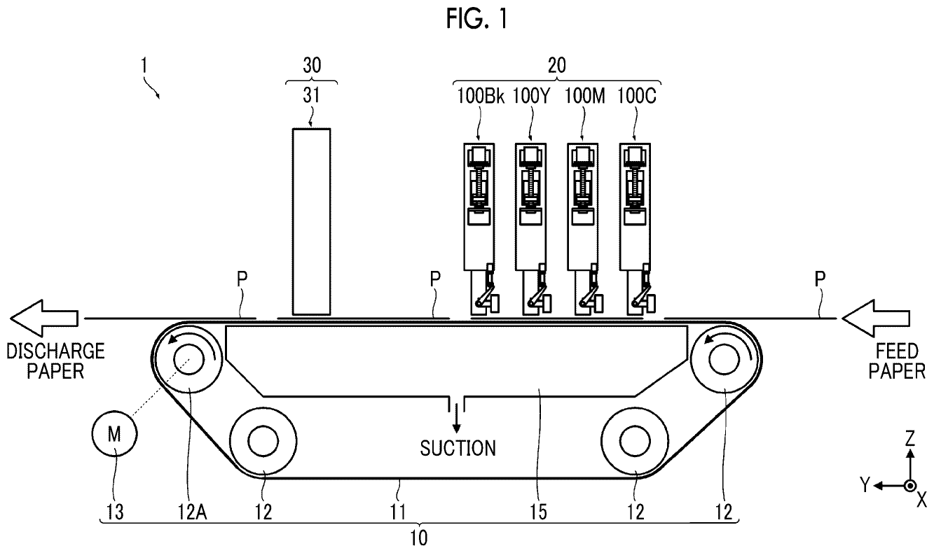

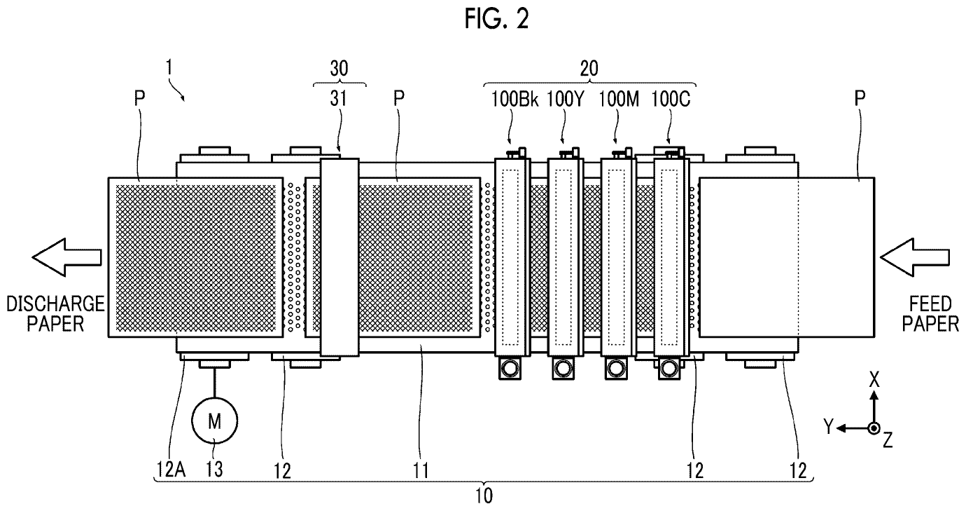

FIG. 1 is a side view showing a schematic configuration of the ink jet printer. FIG. 2 is a plan view showing a schematic configuration of the ink jet printer.

As shown in FIGS. 1 and 2, the ink jet printer 1 of the present embodiment comprises a paper transport unit 10 that transports paper P, a printing unit 20 that prints an image on the paper P, an image reading unit 30 that reads the image printed on the paper P, and the like. The paper P is formed of sheet paper. The paper P is an example of a medium.

### Paper Transport Unit

The paper transport unit 10 transports the paper P along a specified path. As an example, in the present embodiment, the paper P is transported by the belt. That is, the paper P is adsorbed to the surface of the running belt 11 and transported.

The belt 11 is formed of an endless belt. The belt 11 is wound around a plurality of rollers 12 including the driving roller 12A, and a running path is set. A belt drive motor 13 is connected to the driving roller 12A as a drive source. The belt 11 travels along the path by rotating the driving roller 12A by the belt drive motor 13. In the present embodiment, the paper P is transported by using a section in which the belt 11 travels horizontally. Therefore, the paper P is horizontally transported (in FIG. 1, the paper P is horizontally transported from the right side to the left side of the paper surface).

The paper P is adsorbed to the surface of the belt 11 and transported. A method of adsorbing the paper P to the belt 11 is not particularly limited. As an example, in the present embodiment, the paper P is adsorbed to the belt 11 using air pressure (negative pressure). In this case, the suction unit 15 is provided inside the belt 11, and suction holes are provided in the belt 11. By suctioning from the inside of the belt 11 by the suction unit 15, the paper P is adsorbed onto the surface of the belt 11 via the suction hole. In addition to the above, a method of using static electricity (so-called electrostatic adsorption) or the like can also be employed for the adsorption of the paper P.

The paper P is supplied to the paper transport unit 10 from a paper feeding unit (not shown). The paper P is pre-treated as necessary. For example, a predetermined treatment liquid is applied to the surface. In a case where the pre-treatment is performed, a pre-treatment unit is provided in front of the printing unit 20.

The paper P after printing is discharged to a paper discharging unit (not shown). The paper P after printing is post-treated before discharge as necessary. For example, a coating treatment such as varnish and a drying treatment are performed. In a case where the post-treatment is performed, a post-treatment unit is provided in a rear stage of the image reading unit 30.

### Printing Unit

The printing unit 20 prints a color image on the paper P transported by the paper transport unit 10 in a single pass. As an example, in the present embodiment, a color image is printed on the paper P using inks of four colors of cyan (C), magenta (M), yellow (Y), and black (Bk).

The printing unit 20 comprises the same number of print head units as the number of colors of ink to be used. In the present embodiment, since four color inks are used, four print head units are provided. Specifically, the printing unit 20 comprises a cyan (C) print head unit 100C, a magenta (M) print head unit 100M, a yellow (Y) print head unit 100Y, and a black (Bk) print head unit 100Bk.

Each of the print head units 100C, 100M, 100Y, and 100Bk has a print head 200C, 200M, 200Y, and 200Bk, respectively, and ink droplets of corresponding colors are jetted from the print head 200C, 200M, 200Y, and 200Bk. Specifically, the cyan print head unit 100C jets cyan ink droplets from the print head 200C. The magenta print head unit 100M jets magenta ink droplets from the print head 200M. The yellow print head unit 100Y jets yellow ink droplets from the print head 200Y. The black print head unit 100Bk jets black ink droplets from the print head 200Bk. The configuration of the print head unit will be described later.

Each of the print head units 100C, 100M, 100Y, and 100Bk is disposed at regular intervals on the transport path of the paper P. In the present embodiment, the paper P is horizontally transported and the paper P is disposed at regular intervals in the horizontal direction. Each of the print head units 100C, 100M, 100Y, and 100Bk is assembled to a frame (not shown, a frame of the ink jet printer 1) and is installed at a predetermined position.

In the paper P, ink droplets of each color are applied to the surface in the process of passing through each of the print head units 100C, 100M, 100Y, and 100Bk, and a color image is printed on the surface.

### Image Reading Unit

The image reading unit 30 reads an image printed on the paper P. The image reading unit 30 comprises an image reading device 31. The image reading device 31 is configured by a line scanner, and reads an image from the paper P that is horizontally transported by the paper transport unit 10.

### Print Head Unit

As described above, the printing unit 20 of the ink jet printer 1 of the present embodiment comprises four print head units 100C, 100M, 100Y, and 100Bk. The configurations of the print head units 100C, 100M, 100Y, and 100Bk are the same as each other except that the types (colors) of the inks jetted from the print heads 200C, 200M, 200Y, and 200Bk are different from each other. Here, the configuration of the common print head unit 100 will be described. In the present embodiment, the print head unit 100 is an example of a head unit.

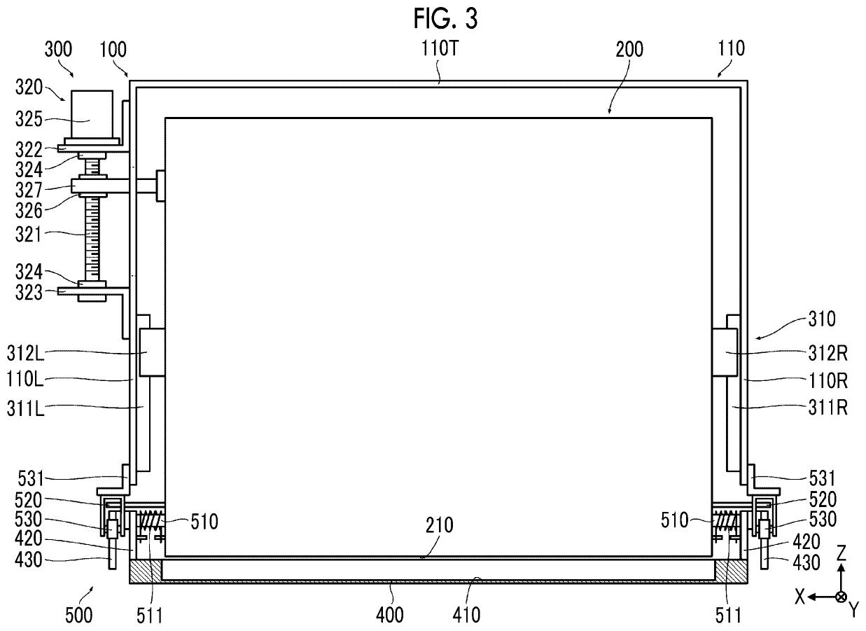

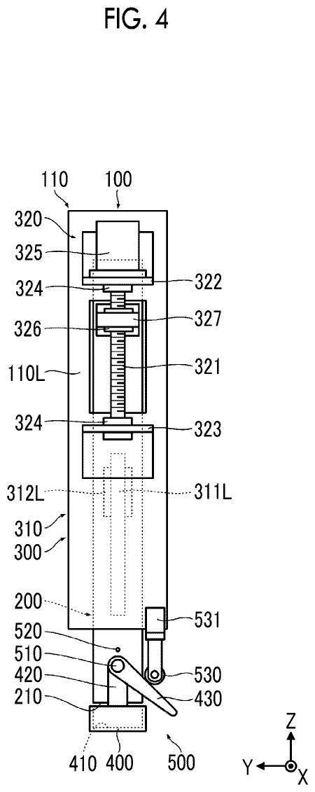

FIG. 3 is a front view of the print head unit. FIG. 4 is a side view of the print head unit.

As shown in FIGS. 3 and 4, the print head unit 100 comprises a base frame 110, a print head 200, a print head elevating mechanism 300, a cap 400, a cap opening and closing mechanism 500, and the like. The cap 400 and the cap opening and closing mechanism 500 constitute a cap mechanism of the print head 200.

### Base Frame

The base frame 110 is a frame that serves as a base of the print head unit 100. The print head 200, the print head elevating mechanism 300, the cap 400, the cap opening and closing mechanism 500, and the like are assembled and integrated with the base frame 110.

The base frame 110 has a top surface portion 110T and side wall portions 110L and 110R that vertically extend from both ends of the top surface portion 110T, and has a reverse U-shape or a gate shape in front view as shown in FIG. 3.

### Print Head

The print head 200 is a so-called line head and has a configuration capable of printing a desired image in a single pass. Therefore, the printing width (printed letter width) covers the paper width. As an example, the print head 200 of the present embodiment has a flat rectangular parallelepiped shape as a whole, and has a nozzle surface (head face surface) 210 at a distal end portion (lower end portion in FIGS. 3 and 4). The nozzle surface 210 is a surface on which the nozzles are disposed.

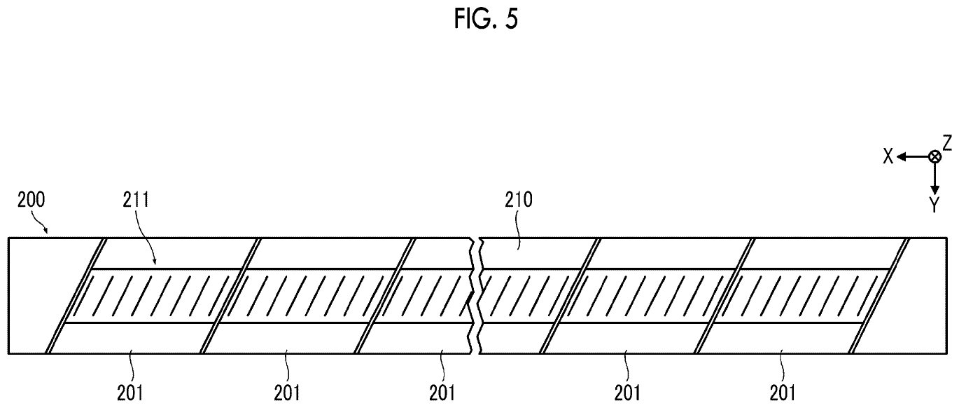

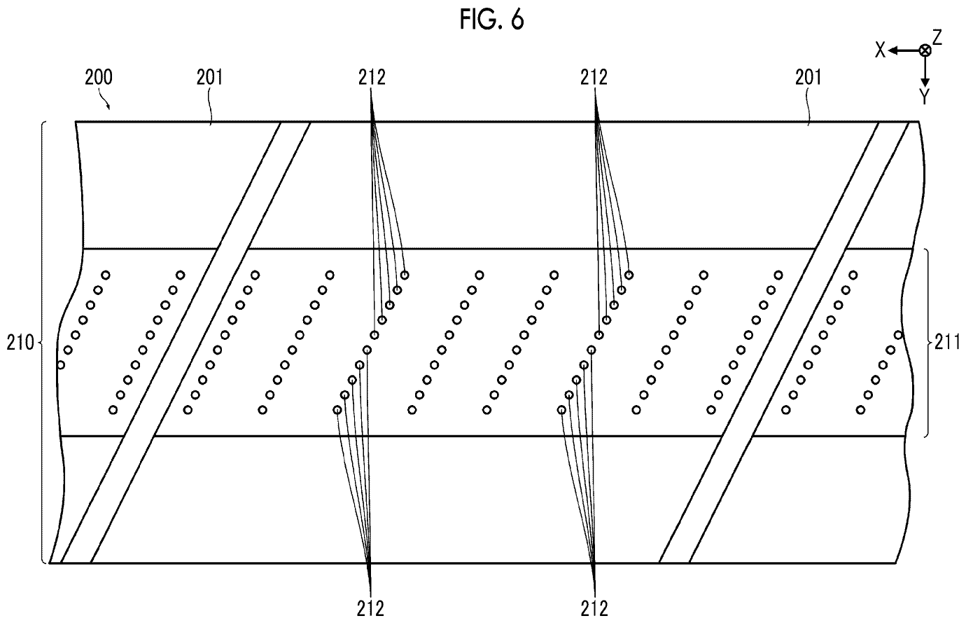

FIG. 5 is a diagram showing a schematic configuration of the nozzle surface. In addition, FIG. 6 is an enlarged view of a part of the nozzle surface. FIGS. 5 and 6 show an example of a case where the print head 200 is configured by connecting a plurality of head modules 201 to each other. Since this type of configuration is known, the details thereof will be omitted.

In FIGS. 5 and 6, the Y direction is a transport direction of the paper P, and the X direction is a direction (a width direction of the paper P) orthogonal to the transport direction of the paper P. A transport direction of the paper P is a front-rear direction of the print head 200, and an upstream side in the transport direction is a front side (front surface side), and a downstream side is a rear side (rear surface side).

As shown in FIG. 5, the print head 200 of the present embodiment has a rectangular nozzle surface 210. The nozzle surface 210 is configured by a flat surface (including a range that is recognized as being substantially flat). The nozzle surface 210 comprises a strip-shaped nozzle region 211 in a central portion. The nozzle region 211 is a region in which a plurality of nozzles 212 are disposed. In the present embodiment, the width of the paper Pis set to a certain width (including a range that is regarded as substantially constant) along the width direction (X direction).

A plurality of nozzles 212 are disposed in the nozzle region 211 to realize a desired resolution. As an example, in the present embodiment, as shown in FIG. 6, the nozzles 212 are disposed in a matrix shape, and a desired resolution (for example, 1200 dpi) is realized.

In FIGS. 5 and 6, the X direction (longitudinal direction of the nozzle surface 210) is a substantially nozzle 212 arrangement direction. In the print head 200 assembled to the base frame 110, a nozzle surface 210 at a distal end is disposed to face the paper P transported by the paper transport unit 10. In addition, the arrangement direction of the nozzles 212 is disposed orthogonal to the transport direction of the paper P. As described above, in the present embodiment, since the paper P is horizontally transported, the nozzle surface 210 of the print head 200 is disposed horizontally. In the present embodiment, the print head 200 is an example of a recording head.

### Print Head Elevating Mechanism

The print head elevating mechanism 300 moves the print head 200 forward and backward with respect to the paper P transported by the paper transport unit 10. In the present embodiment, since the paper P is horizontally transported, the print head elevating mechanism 300 is configured as a mechanism that elevates and lowers (moves up and down) the print head 200.

The print head elevating mechanism 300 comprises a support portion 310 that supports the print head 200 to be movable with respect to the base frame 110, and a driving unit 320 that elevates and lowers the print head 200.

The support portion 310 supports the print head 200 to be slidable with respect to the base frame 110 via guide rails 311L and 311R and sliders 312L and 312R. As shown in FIG. 3, the base frame 110 comprises guide rails 311L and 311R in the side wall portions 110L and 110R. The guide rails 311L and 311R are disposed along a vertical direction (Z direction). On the other hand, the print head 200 comprises sliders 312L and 312R that slide along the guide rails 311L and 311R. The print head 200 is assembled to the base frame 110 by engaging the sliders 312L and 312R with the guide rails 311L and 311R. Accordingly, the print head 200 is slidably supported with respect to the base frame 110.

The driving unit 320 raises and lowers the print head 200 by a so-called feed screw mechanism. As shown in FIGS. 3 and 4, a screw shaft 321 is disposed along the vertical direction (Z direction) on one side wall portion 110L of the base frame 110. The screw shaft 321 is rotatably supported by the brackets 322 and 323 attached to the side wall portion 110L of the base frame 110 via a bearing 324. The elevating drive motor 325 is connected to the screw shaft 321. The elevating drive motor 325 is provided on one bracket 322 and rotationally drives the screw shaft 321. The screw shaft 321 comprises a nut 326. The nut 326 is connected to the print head 200 via a connection bar 327. Accordingly, in a case where the screw shaft 321 is rotated via the elevating drive motor 325, the nut 326 moves in the up-down direction along the screw shaft 321. Then, as the nut 326 moves in the up-down direction, the print head 200 connected to the nut 326 moves in the up-down direction together with the nut 326.

### Cap

The cap 400 covers the nozzle surface 210 of the print head 200 in a case of not being used, thereby suppressing the evaporation of the solvent from the nozzle 212, the adhesion of foreign substances to the nozzle surface, and the like.

As shown in FIGS. 3 and 4, the cap 400 has a hollow shape in which a surface covering the nozzle surface 210 is open. By making the cap 400 have a hollow shape, it is possible to suppress the cap 400 from coming into direct contact with the nozzle 212. In addition, the liquid (including the ink) can be held in the cap 400. In the present embodiment, the cap 400 has a rectangular flat plate shape, and a rectangular recess portion 410 is provided on a surface covering the nozzle surface 210. The recess portion 410 has a width in the longitudinal direction (direction orthogonal to the transport direction of the paper P) that is slightly wider than the width of the nozzle surface 210 in the longitudinal direction. In addition, the width in the direction (the transport direction of the paper P) orthogonal to the longitudinal direction has the same width or a slightly wider width than the width in the direction orthogonal to the longitudinal direction of the nozzle surface 210.

As shown in FIGS. 3 and 4, the cap 400 is positioned directly below the print head 200 and covers the nozzle surface 210 of the print head 200. In this case, a surface (upper surface in FIGS. 3 and 4) of the cap 400 that covers the nozzle surface 210 is parallel (including a range recognized as substantially parallel) to the nozzle surface 210.

### Cap Opening and Closing Mechanism

The cap opening and closing mechanism 500 moves the cap 400 between an open position and a closed position to open and close the cap 400. The open position is a position where the nozzle surface 210 is opened, and the closed position is a position where the nozzle surface 210 is covered. The cap 400 moves between the open position and the closed position by swinging (arc motion) about the axis (rod) provided in the print head 200. In the present embodiment, the closed position is an example of a third position, and the open position is an example of a fourth position. In addition, the swing about the axis (rod) is an example of arc motion.

The cap opening and closing mechanism 500 opens and closes the cap 400 by using the lifting and lowering of the print head 200. Therefore, the cap 400 is opened and closed in conjunction with the elevating of the print head 200. In the present embodiment, the cap opening and closing mechanism 500 is an example of an interlocking mechanism.

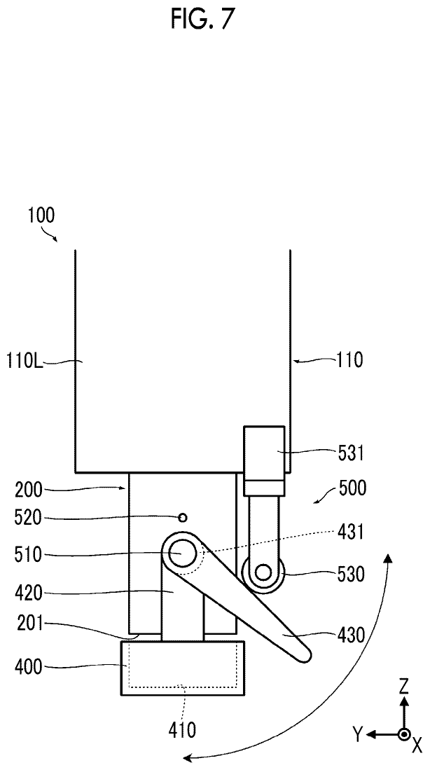

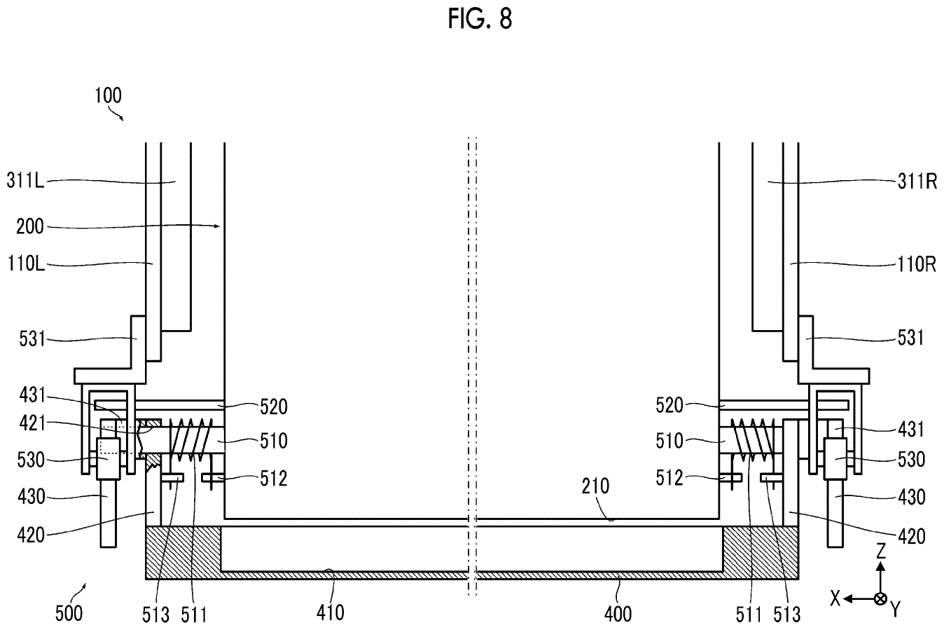

FIG. 7 is a side view showing a configuration of the cap opening and closing mechanism. FIG. 8 is a front view showing a configuration of the cap opening and closing mechanism.

As shown in FIGS. 7 and 8, the print head 200 is provided with round bar-shaped rods 510 on both side surfaces. The rod 510 is disposed in parallel (including a range recognized as substantially parallel) with the nozzle surface 210 and is disposed along the arrangement direction (longitudinal direction of the nozzle surface 210) of the nozzles 212. The rod 510 functions as a shaft that supports the cap 400.

The cap 400 comprises arm portions 420 at both end portions in the longitudinal direction. The arm portion 420 is provided with a mounting hole 421 at a distal end portion (an upper end portion in FIGS. 7 and 8). The mounting hole 421 is formed of a hole into which the rod 510 can be fitted.

The cap 400 is mounted on the print head 200 by fitting the rod 510 into the mounting hole 421. The cap 400 mounted on the print head 200 is supported to be swingable with a rod 510 as a shaft (swing shaft).

The cap 400 is biased in an opening direction (a direction in which the cap 400 swings from the closed position to the open position) by a spring 511 mounted on the rod 510. The spring 511 is configured by, for example, a torsion spring (twisted coil spring). One end of the spring 511 is hooked on a spring hook portion 512 provided on the print head 200, and the other end of the spring 511 is hooked on a spring hook portion 513 provided on the arm portion 420, so that the cap 400 is biased in the opening direction. In the present embodiment, the spring 511 is an example of a biasing member.

The cap 400 comprises levers 430 at both end parts in the longitudinal direction. The lever 430 has a cylindrical shaft portion 431 at a proximal end portion thereof, and the shaft portion 431 is fixed to a distal end of the arm portion 420 and is integrated with the arm portion 420. The cylindrical shaft portion 431 has an inner diameter into which the rod 510 can be fitted and is disposed coaxially with the mounting hole 421 of the arm portion 420. In the cap 400, in a case of being mounted on the print head 200, the rod 510 is also fitted into a shaft portion 431 of the lever 430. Therefore, the lever 430 swings with the rod 510 as an axis. As the lever 430 swings, the arm portion 420 of the cap 400 integrated with the lever 430 also swings with the rod 510 as an axis. Therefore, the cap 400 also swings.

The print head 200 is provided with stopper pins 520 on both side surfaces. The stopper pin 520 is disposed in parallel with the rod 510. The cap 400 biased in the opening direction by the spring 511 is held at a predetermined position by the lever 430 abutting on the stopper pin 520. In the present embodiment, the lever 430 abuts on the stopper pin 520 in the open position.

The base frame 110 is provided with the contactor 530 on both the side wall portions 110L and 110R corresponding to the lever 430 of the cap 400. The contactor 530 is attached to a predetermined position of the base frame 110 via a bracket 531. In the present embodiment, the contactor 530 is configured by a roller. The contactor 530 is rotatably held around an axis parallel to the rod 510.

The contactor 530 comes into contact with (engages with) the lever 430 of the cap 400 mounted on the print head 200. The cap 400 biased by the spring 511 is held in a predetermined posture by the lever 430 coming into contact with the contactor 530.

The contactor 530 is held at a constant position of the base frame 110. Therefore, in a case where the print head 200 is slid (raised and lowered) with respect to the base frame 110, the lever 430 is pushed by the contactor 530 and swings. As a result, the cap 400 swings (arc motion) with the rod 510 as an axis and moves between the open position and the closed position. In the present embodiment, the contactor 530 is an example of an engaging member.

### Opening and Closing Operation of Cap

As described above, the cap 400 of the present embodiment is opened and closed in conjunction with the elevating of the print head 200.

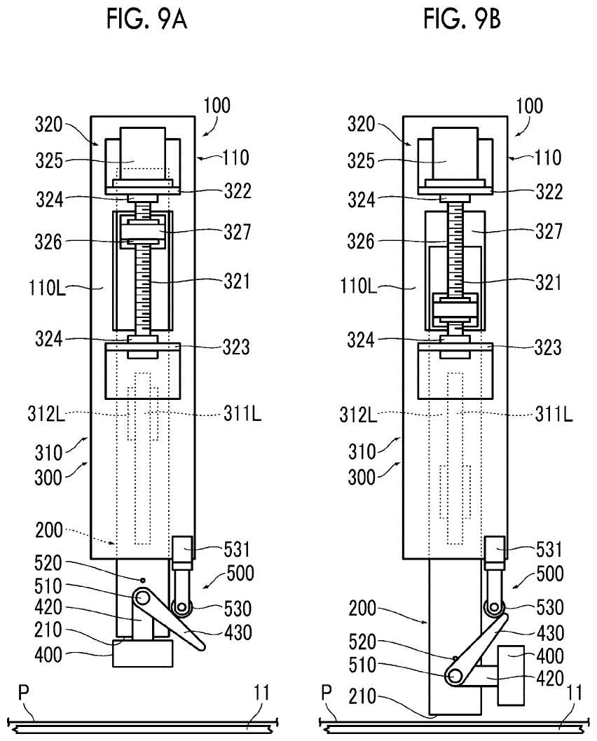

FIGS. 9A and 9B are diagrams showing an elevating operation of the print head.

In the print head 200, a nozzle surface 210 at a distal end is disposed to face the paper P transported by the paper transport unit 10. In the present embodiment, since the paper P is horizontally transported, the nozzle surface 210 is horizontally disposed to face the paper P.

The print head 200 is driven and moved up and down by the print head elevating mechanism 300. In the present embodiment, the print head 200 is vertically moved up and down with respect to the paper P that is horizontally transported. The print head 200 ascends to be spaced from the paper P and descends to approach the paper P.

FIG. 9A shows a position of the print head 200 during waiting (during non-use). As shown in FIG. 9A, in a case of waiting, the print head 200 is positioned at a position where the nozzle surface 210 is spaced apart from the belt 11 by a large distance. A position of the print head 200 in a case of waiting is referred to as a “waiting position”.

FIG. 9B shows the position of the print head 200 during printing. As shown in FIG. 9B, during printing, the print head 200 is close to the nozzle surface 210 to the belt 11. A position of the print head 200 during printing is referred to as a “printing position”. At the printing position, the print head 200 is positioned at a predetermined height from the paper P by the nozzle surface 210.

The cap 400 swings in conjunction with the elevating of the print head 200 and is automatically opened and closed. Specifically, in a case where the print head 200 moves to the “waiting position”, the cap 400 moves to the “closed position”, and in a case where the print head 200 moves to the “printing position”, the cap 400 moves to the “open position”.

In the present embodiment, the waiting position of the print head 200 is an example of a first position, and the printing position is an example of a second position.

### Opening Operation

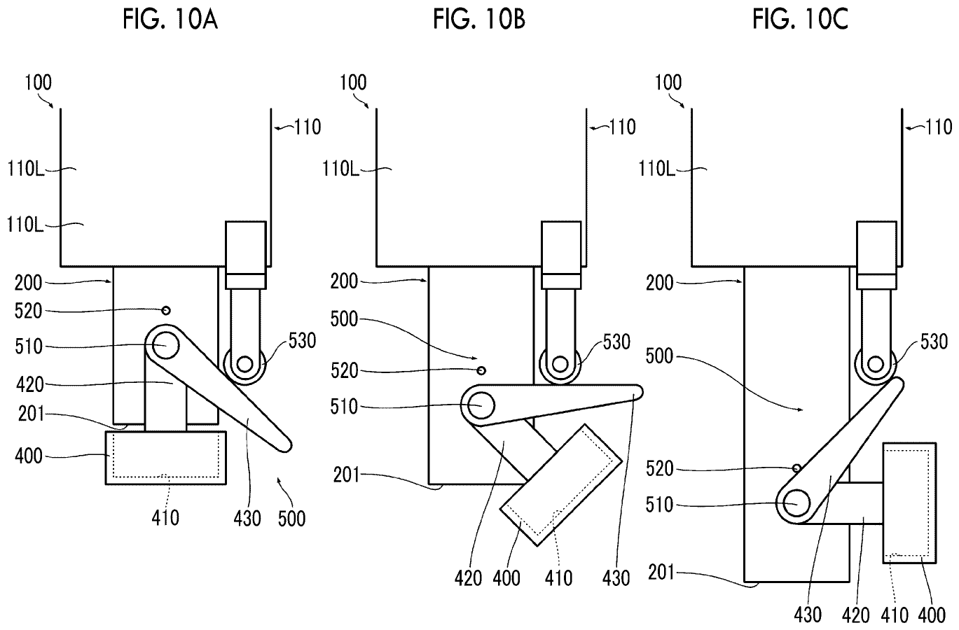

FIGS. 10A to 10C are diagrams showing a change in a state of the cap due to the elevating of the print head.

FIG. 10A shows a state in which the print head 200 is positioned at the waiting position. FIG. 10C shows a state in which the print head 200 is positioned at the printing position. FIG. 10B shows a state in which the print head 200 is positioned between the waiting position and the printing position.

As shown in FIG. 10A, in a case where the print head 200 is positioned at the waiting position, the cap 400 is positioned at the closed position. In the closed position, the cap 400 is positioned directly below the print head 200, and a surface (opening surface) having an opening of the recess portion 410 is disposed to face the nozzle surface 210. As a result, the nozzle surface 210 is covered with the cap 400. That is, the nozzle surface 210 is capped.

In the cap 400 positioned at the closed position, the nozzle surface 210 is disposed with the nozzle region 211 inside the opening portion of the recess portion 410. Accordingly, for example, in a case of the preliminary discharge or the purging, the ink discharged or emitted from the nozzle 212 can be recovered by the recess portion 410.

The cap 400 is held at the closed position by the levers 430 at both ends abutting on the contactors 530 provided in the base frame 110. That is, the cap 400 biased in the opening direction is held at the closed position by the contactor 530 functioning as a stopper.

As shown in FIG. 10B, in a case where the print head 200 descends from the waiting position toward the printing position, the cap 400 moves (swings) from the closed position toward the open position in conjunction with the print head 200. In this case, the cap 400 is moved from the closed position toward the open position by the biasing force of the spring 511.

As shown in FIG. 10C, in a case where the print head 200 is further lowered and is positioned at the printing position, the cap 400 moves to the open position. In the open position, the cap 400 is completely retracted from a lower portion of the print head 200 and is located on the front surface side. In the present embodiment, the cap 400 is rotated by 90 degrees from the closed position and is positioned at the open position. Therefore, the cap 400 is held in a posture in which the opening surface is perpendicular to the nozzle surface 210.

The cap 400 is positioned at the open position and is retracted from the lower portion of the print head 200, so that the nozzle surface 210 is opened. As a result, the ink droplets can be jetted toward the paper P.

The cap 400 is held at the open position by the levers 430 at both ends coming into contact with the contactor 530. That is, the cap 400 biased in the opening direction is held at the open position by the contactor 530 functioning as a stopper.

In the present embodiment, in a case where the print head 200 is positioned at the printing position, the lever 430 comes into contact with the stopper pin 520. Therefore, the movement of the cap 400 is also blocked by the stopper pin 520. Since the lever 430 abuts on the stopper pin 520, the cap 400 is held at the open position even in a case where the print head 200 is further moved downward from the printing position.

### Closing Operation

In a case where the print head 200 ascends from the printing position to the waiting position, the lever 430 of the cap 400 is pushed by the contactor 530 against a biasing force of the spring 511. As a result, the cap 400 swings in a closing direction (direction from the open position to the closed position).

As shown in FIG. 10A, in a case where the print head 200 is moved to the waiting position, the cap 400 is positioned at the closed position. As a result, the nozzle surface 210 is covered with the cap 400. The cap 400 is held in the closed position by the lever 430 abutting on the contactor 530.

As described above, with the cap mechanism of the present embodiment, the cap 400 is automatically opened and closed in conjunction with the elevating operation (advancing and retreating operation) of the print head 200. Accordingly, the nozzle surface 210 can be reliably capped at the waiting position. In addition, the nozzle surface 210 can be reliably opened at the printing position.

In addition, according to the present embodiment, since the opening and closing of the cap 400 does not require a separate power, the configuration of the cap mechanism can be simplified. In addition, this makes it possible to make the entire printer including the cap mechanism more compact.

### Modification Example

### Modification Example of Cap Opening and Closing Mechanism

### (1) First Modification Example of Cap Opening and Closing Mechanism

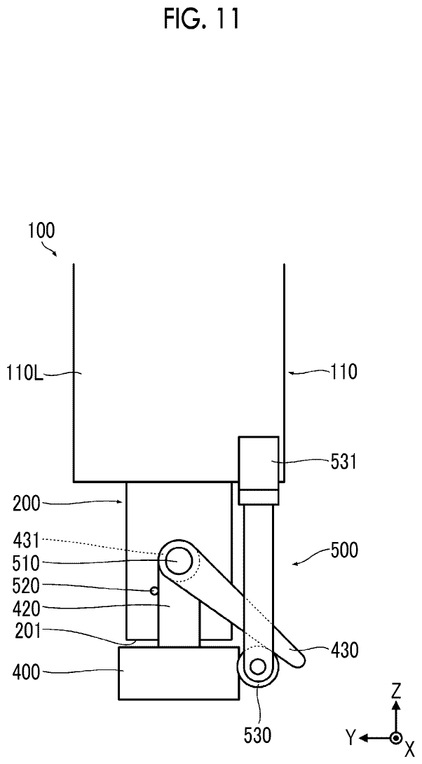

FIG. 11 is a view showing a first modification example of the cap opening and closing mechanism.

The cap opening and closing mechanism 500 of the present example shows an example in which the cap 400 is biased in the opening direction. In this case, the cap 400 is biased in a direction (a clockwise direction in FIG. 11) from the open position to the closed position by a spring (not shown).

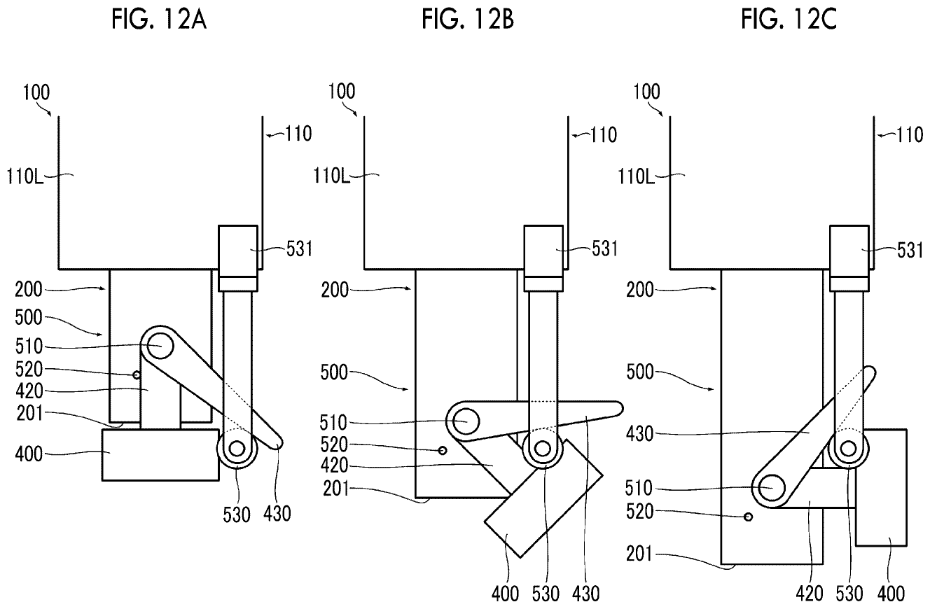

FIGS. 12A to 12C are diagrams showing a change in a state of the cap due to the elevating of the print head.

FIG. 12A shows a state in which the print head 200 is positioned at the waiting position. FIG. 12C shows a state in which the print head 200 is positioned at the printing position. FIG. 12B shows a state in which the print head 200 is positioned between the waiting position and the printing position.

The cap 400 biased in the closing direction is held at a predetermined position with respect to the print head 200 by the lever 430 abutting onto the contactor 530. The contactor 530 functions as a stopper, whereby the contactor 530 is held at a predetermined position.

As shown in FIG. 12A, in a case where the print head 200 is positioned at the waiting position, the cap 400 is positioned at the closed position. In the closed position, the cap 400 is positioned directly below the print head 200, and the opening surface is disposed to face the nozzle surface 210. As a result, the nozzle surface 210 is covered with the cap 400.

As shown in FIG. 12B, in a case where the print head 200 descends from the waiting position toward the printing position, the lever 430 of the cap 400 is pulled in the opening direction against the biasing force of the spring by the action of the contactor 530. As a result, the cap 400 swings in the opening direction.

As shown in FIG. 12C, in a case where the print head 200 is positioned at the printing position, the cap 400 swings to the open position. In the open position, the cap 400 is completely retracted from the lower portion of the print head 200. Accordingly, the nozzle surface 210 is opened, and the ink droplets can be jetted from the nozzle 212 toward the paper P.

In a case where the print head 200 ascends from the printing position to the waiting position, the cap 400 swings in a closing direction by a biasing force of the spring. In a case where the print head 200 is moved to the waiting position, the cap 400 is positioned at the closed position, and the nozzle surface 210 is covered with the cap 400.

As described above, even with the cap opening and closing mechanism 500 of the present example, the cap 400 can be automatically opened and closed in conjunction with the elevating operation of the print head 200.

In the present example, the stopper pin 520 is configured to abut on the arm portion 420 of the cap 400 in the closed position. Therefore, in a case where the print head 200 is moved to the waiting position, the cap 400 is held at the closed position by the stopper pin 520. In this case, even in a case where the print head 200 further ascends, the cap 400 is held at the closed position.

### (2) Second Modification Example of Cap Opening and Closing Mechanism

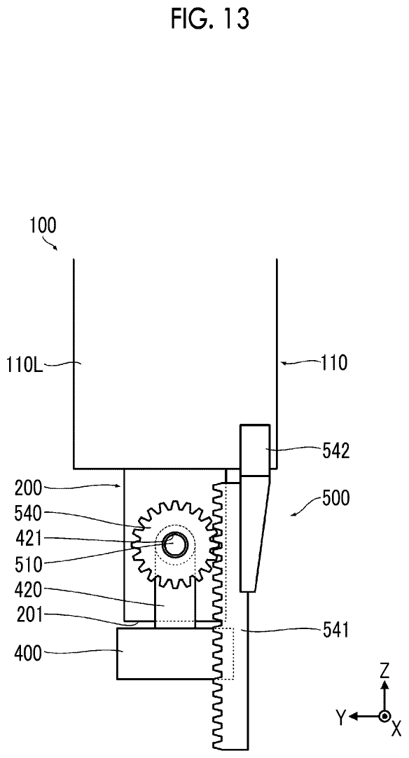

FIG. 13 is a view showing a second modification example of the cap opening and closing mechanism.

In the cap opening and closing mechanism 500 of the present example, the cap 400 is opened and closed by using a gear. Specifically, the rack and the pinion are used to convert the linear motion of the print head 200 caused by the elevating into rotational motion (swing) of the cap 400, and the cap 400 is opened and closed.

The cap 400 is provided with a pinion 540. The pinion 540 is provided at a distal end (upper end in FIG. 13) of the arm portion 420 on both sides and is disposed on the same axis as the mounting hole 421. In addition, the pinion 540 is fixed and attached to the arm portion 420. Therefore, in a case where the pinion 540 is rotated about the axis, the arm portion 420 is also rotated integrally with the pinion 540.

In the cap 400 mounted on the print head 200, the pinion 540 is disposed coaxially with the rod 510. Therefore, in a case where the pinion 540 is rotated, the arm portion 420 is rotated about the rod 510. As a result, the cap 400 swings with the rod 510 as an axis. That is, in a case where the pinion 540 is rotated, the cap 400 swings.

The base frame 110 comprises a rack 541 that engages with the pinion 540. The rack 541 is attached to the side wall portions 110L and 110R of the base frame 110 via a bracket 542. The rack 541 is disposed along the movement direction of the print head 200. In the present embodiment, the print head 200 moves up and down (elevates) perpendicularly to the horizontal plane. Therefore, the rack 541 is disposed along the vertical direction (Z direction in FIG. 13).

In a case where the print head 200 is elevated with respect to the base frame 110, the rack 541 reciprocates linearly with respect to the pinion 540. As a result, the pinion 540 rotates, and the cap 400 swings. In addition, in a case where the print head 200 is stopped, the posture of the cap 400 is held by the action of the pinion 540 that engages with the rack 541.

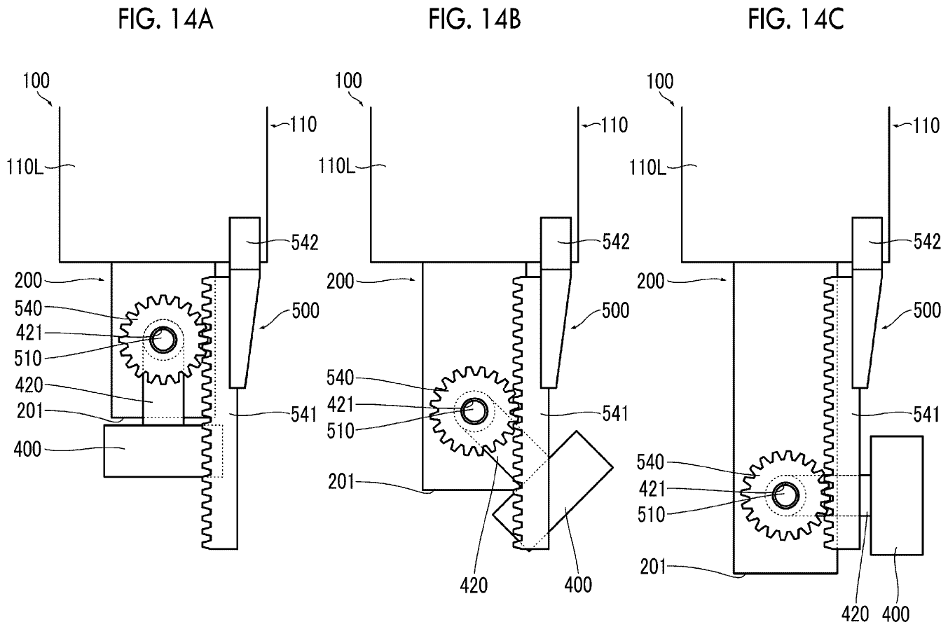

FIGS. 14A to 14C are diagrams showing a change in a state of the cap due to the elevation of the print head.

FIG. 14A shows a state in which the print head 200 is positioned at the waiting position. FIG. 14C shows a state in which the print head 200 is positioned at the printing position. FIG. 14B shows a state in which the print head 200 is positioned between the waiting position and the printing position.

As shown in FIG. 14A, in a case where the print head 200 is positioned at the waiting position, the cap 400 is positioned at the closed position. In the closed position, the cap 400 is positioned directly below the print head 200, and the opening surface is disposed to face the nozzle surface 210. As a result, the nozzle surface 210 is covered with the cap 400.

As shown in FIG. 14B, in a case where the print head 200 descends from the waiting position toward the printing position, the pinion 540 descends with respect to the stationary rack 541. As a result, the pinion 540 rotates in the opening direction (counterclockwise direction in FIGS. 14A to 14C), and the cap 400 swings in the opening direction.

Further, in a case where the print head 200 is positioned at the printing position as shown in FIG. 14C, the cap 400 swings to the open position. In the open position, the cap 400 is completely retracted from the lower portion of the print head 200. Accordingly, the nozzle surface 210 is opened, and the ink droplets can be jetted toward the paper P.

In a case where the print head 200 ascends from the printing position to the waiting position, the pinion 540 ascends with respect to the stationary rack 541. As a result, as shown in FIG. 14B, the pinion 540 rotates in the closing direction (clockwise direction in FIGS. 14A to 14C), and the cap 400 swings in the closing direction. In a case where the print head 200 is moved to the waiting position, as shown in FIG. 14A, the cap 400 is positioned at the closed position, and the nozzle surface 210 is covered with the cap 400.

As described above, even with the cap opening and closing mechanism 500 of the present example, the cap 400 can be automatically opened and closed in conjunction with the elevating operation of the print head 200.

In the present example, the cap opening and closing mechanism 500 is configured by the rack 541 and the pinion 540, but the cap opening and closing mechanism 500 may be configured by further combining gears. In addition, in the present example, the spring as the biasing member is not required in principle.

### (3) Third Modification Example of Cap Opening and Closing Mechanism

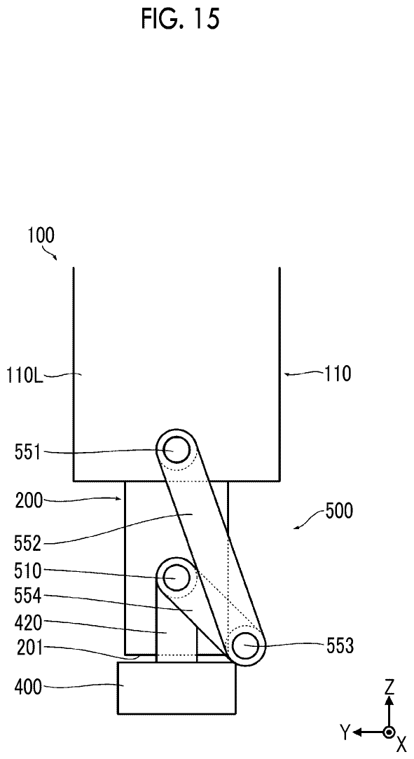

FIG. 15 is a view showing a third modification example of the cap opening and closing mechanism.

The cap opening and closing mechanism 500 of the present example opens and closes the cap 400 by using a so-called link mechanism. FIG. 15 shows an example in which a slider link mechanism is used.

As shown in FIG. 15, one end of a first link 552 is connected to the side wall portions 110L and 110R on both sides of the base frame 110 via a first joint 551 (only the first link 552 connected to one side wall portion 110L is shown in FIG. 15). The other end of the first link 552 is connected to one end of a second link 554 via a second joint 553. The other end of the second link 554 is connected to the print head 200 via the rod 510.

The print head 200 functions as a slider in the slider link mechanism. In a case where the print head 200 slides (elevates) with respect to the base frame 110, the second link 554 swings with the rod 510 as an axis.

The arm portion 420 is fixed to the second link 554 that swings. Accordingly, the arm portion 420 swings in conjunction with the second link 554. Then, the arm portion 420 swings, and thus the cap 400 swings with the rod 510 as an axis.

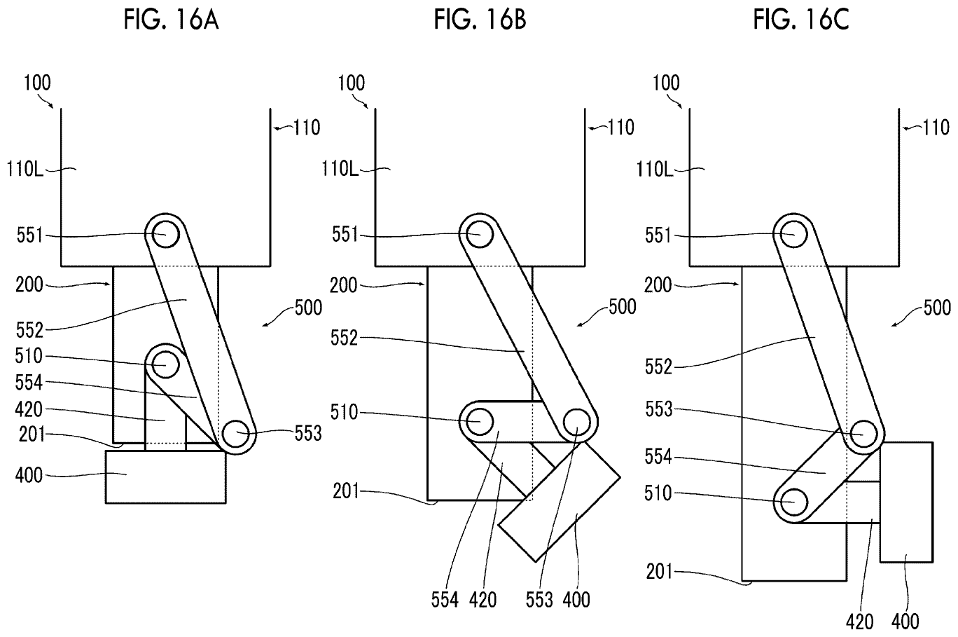

FIGS. 16A to 16C are diagrams showing a change in a state of the cap due to the elevating of the print head.

FIG. 16A shows a state in which the print head 200 is positioned at the waiting position. FIG. 16C shows a state in which the print head 200 is positioned at the printing position. FIG. 16B shows a state in which the print head 200 is positioned between the waiting position and the printing position.

As shown in FIG. 16A, in a case where the print head 200 is positioned at the waiting position, the cap 400 is positioned at the closed position. In the closed position, the cap 400 is positioned directly below the print head 200, and the opening surface is disposed to face the nozzle surface 210. As a result, the nozzle surface 210 is covered with the cap 400.

As shown in FIG. 16B, in a case where the print head 200 descends from the waiting position toward the printing position, the second link 554 swings in an opening direction (counterclockwise direction in FIGS. 16A to 16C) about the rod 510. As a result, the cap 400 fixed to the second link 554 swings in the opening direction via the arm portion 420.

Further, in a case where the print head 200 is positioned at the printing position as shown in FIG. 16C, the cap 400 swings to the open position. In the open position, the cap 400 is completely retracted from the lower portion of the print head 200. Accordingly, the nozzle surface 210 is opened, and the ink droplets can be jetted toward the paper P.

In a case where the print head 200 ascends from the printing position to the waiting position, the second link 554 swings in a closing direction (a clockwise direction in FIGS. 16A to 16C) about the rod 510. As a result, as shown in FIG. 16B, the cap 400 fixed to the second link 554 swings in the closing direction via the arm portion 420. In a case where the print head 200 is moved to the waiting position, as shown in FIG. 16A, the cap 400 is positioned at the closed position, and the nozzle surface 210 is covered with the cap 400.

As described above, even with the cap opening and closing mechanism 500 of the present example, the cap 400 can be automatically opened and closed in conjunction with the elevating operation of the print head 200.

### (4) Fourth Modification Example of Cap Opening and Closing Mechanism

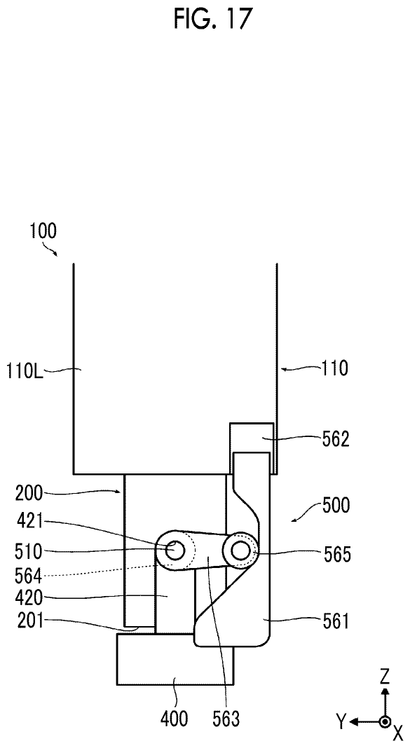

FIG. 17 is a view showing a fourth modification example of the cap opening and closing mechanism.

The cap opening and closing mechanism 500 of the present example opens and closes the cap 400 by using a so-called cam mechanism.

As shown in FIG. 17, the base frame 110 comprises plate cams 561 in both side wall portions 110L and 110R (only the plate cam 561 of one side wall portion 110L is shown in FIG. 17). The plate cam 561 is provided on both side wall portions 110L and 110R of the base frame 110 via a bracket 562.

The cap 400 is provided with a lever 563 at a distal end of each of the arm portions 420 on both sides. The lever 563 has a cylindrical shaft portion 564 at a proximal end portion thereof, and the shaft portion 564 is fixed to a distal end of the arm portion 420 and is integrated with the arm portion 420. The shaft portion 564 has an inner diameter into which the rod 510 can be fitted and is disposed coaxially with the mounting hole 421 of the arm portion 420.

A contactor 565 that is engaged with the plate cam 561 is provided at a distal end of the lever 563. The contactor 565 is configured by a roller. The plate cam 561 is configured by a so-called straight cam (linear cam) and moves linearly relative to the print head 200.

The cap 400 is biased in a closing direction (a clockwise direction in FIG. 17) by a spring (not shown). As a result, the contactor 565 is pressed and abutted against the plate cam 561.

The print head 200 is raised and lowered, so that the lever 563 swings under the action of the contactor 565 and the plate cam 561. Accordingly, the cap 400 is opened and closed.

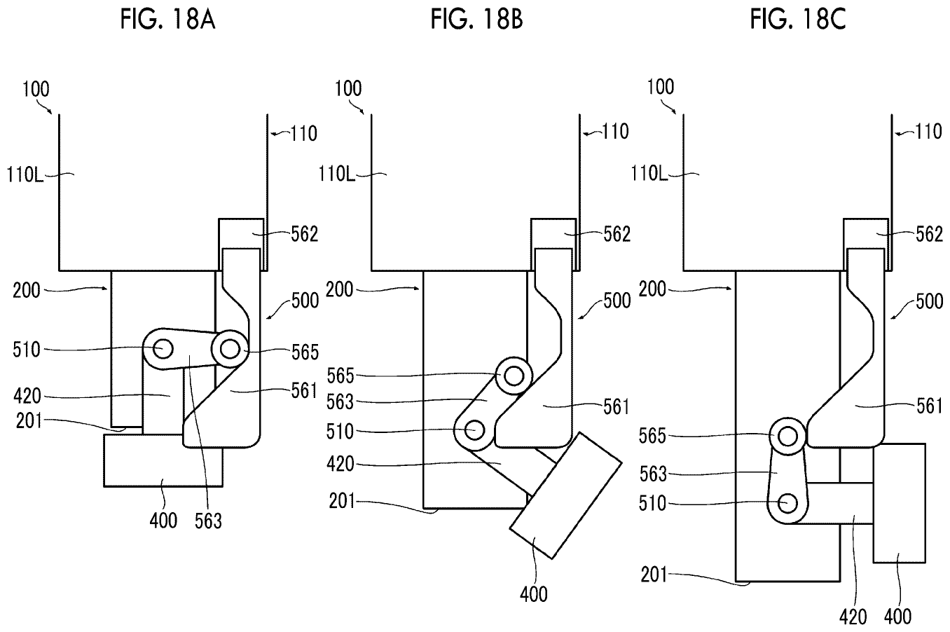

FIGS. 18A to 18C are diagrams showing a change in a state of the cap due to the elevating of the print head.

FIG. 18A shows a state in which the print head 200 is positioned at the waiting position. FIG. 18C shows a state in which the print head 200 is positioned at the printing position. FIG. 18B shows a state in which the print head 200 is positioned between the waiting position and the printing position.

As shown in FIG. 18A, in a case where the print head 200 is positioned at the waiting position, the cap 400 is positioned at the closed position. In the closed position, the cap 400 is positioned directly below the print head 200, and an opening surface of the cap 400 is disposed to face the nozzle surface 210. As a result, the nozzle surface 210 is covered with the cap 400.

As shown in FIG. 18B, in a case where the print head 200 descends from the waiting position toward the printing position, the lever 563 swings in an opening direction (counterclockwise direction in FIG. 18) against the biasing force of the spring due to the action of the contactor 565 and the plate cam 561. As a result, the cap 400 swings in the opening direction.

Further, in a case where the print head 200 is positioned at the printing position as shown in FIG. 18C, the cap 400 swings to the open position. In the open position, the cap 400 is completely retracted from the lower portion of the print head 200. Accordingly, the nozzle surface 210 is opened, and the ink droplets can be jetted toward the paper P.

In a case where the print head 200 ascends from the printing position to the waiting position, the lever 563 swings in a closing direction (clockwise direction in FIGS. 18A to 18C) by the action of the contactor 565 and the plate cam 561. As a result, as shown in FIG. 18B, the cap 400 swings in the closing direction. In a case where the print head 200 is moved to the waiting position, as shown in FIG. 18A, the cap 400 is positioned at the closed position, and the nozzle surface 210 is covered with the cap 400.

As described above, even with the cap opening and closing mechanism 500 of the present example, the cap 400 can be automatically opened and closed in conjunction with the elevating operation of the print head 200.

Although the present example is an example of a case where the cap opening and closing mechanism is configured by a cam mechanism, the cap opening and closing mechanism of the first embodiment is also an example of a case where the cap opening and closing mechanism is configured by a cam mechanism.

### (5) Other Modification Examples of Cap Opening and Closing Mechanism

The cap opening and closing mechanism 500 of the first embodiment employs the torsion spring as the means for biasing the cap 400 in the opening direction, but the means for biasing the cap 400 is not limited thereto. In addition, a tension coil spring, a spiral spring, a leaf spring, or the like can also be employed.

In addition, in each of the above modification examples, the gear mechanism including the rack and the pinion, the link mechanism, and the cam mechanism are employed as the mechanism that converts the linear motion of the print head 200 into the arc motion of the cap 400, but the mechanism that converts the linear motion of the print head 200 into the rotational motion of the cap 400 is not limited thereto. Another conversion mechanism can also be operated. In addition, in the modification examples, the cam mechanism, the link mechanism, and the gear mechanism are used alone, but a configuration in which the mechanisms are appropriately combined can also be adopted.

### Modification Example of Cap

### (1) First Modification Example of Cap

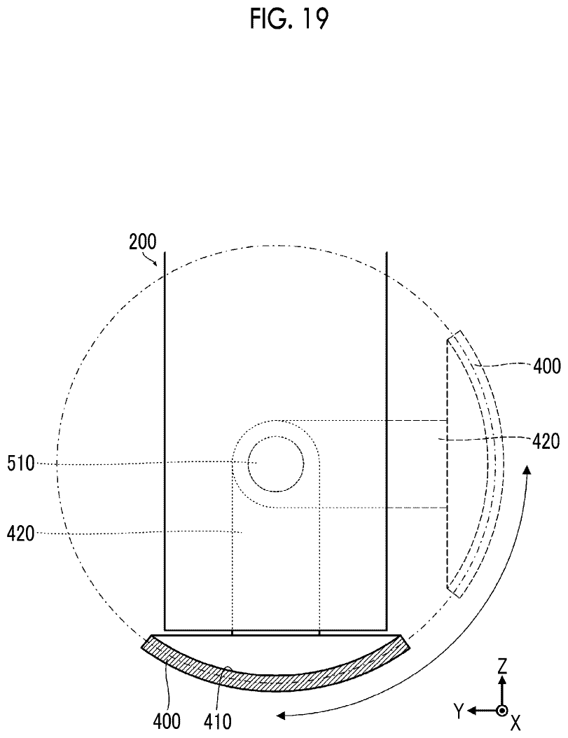

FIG. 19 is a view showing a first modification example of the cap. FIG. 19 shows a cross-sectional shape of the cap 400 in a cross section orthogonal to the swing shaft. In FIG. 19, a solid line indicates a state in which the cap 400 is positioned at the closed position, and a broken line indicates a state in which the cap 400 is positioned at the open position.

As shown in FIG. 19, the cap 400 of the present example has an arc shape in a cross section orthogonal to the swing shaft. The arc constitutes a part of a circle centered on the swing shaft. That is, the cap 400 of the present example has a shape in which a part of a cylinder is cut out.

By having an arc shape, the cap 400 comprises an arc-shaped recess portion 410 on a surface that covers the nozzle surface 210. That is, the cap 400 has a hollow shape in which a surface covering the nozzle surface 210 is open.

By having the recess portion 410 on the surface covering the nozzle surface 210, the cap 400 can collect the ink discharged or discharged from the nozzle 212, for example, in a case of preliminary discharge or purging.

As described above, it is preferable that the cap 400 comprises the recess portion 410 on the surface covering the nozzle surface 210. That is, it is preferable that the cap 400 has a hollow shape in which a surface covering the nozzle surface 210 is opened.

In the hollow-shaped cap having an opening portion with a surface covering the nozzle surface, a peripheral edge portion of the opening portion constitutes a portion closest to the swing shaft in a cross section orthogonal to the swing shaft. In other words, in a cross section orthogonal to the swing shaft, the cap having a portion closest to the swing shaft as the edge portion has a hollow shape in which a surface covering the nozzle surface is open.

### (2) Second Modification Example of Cap

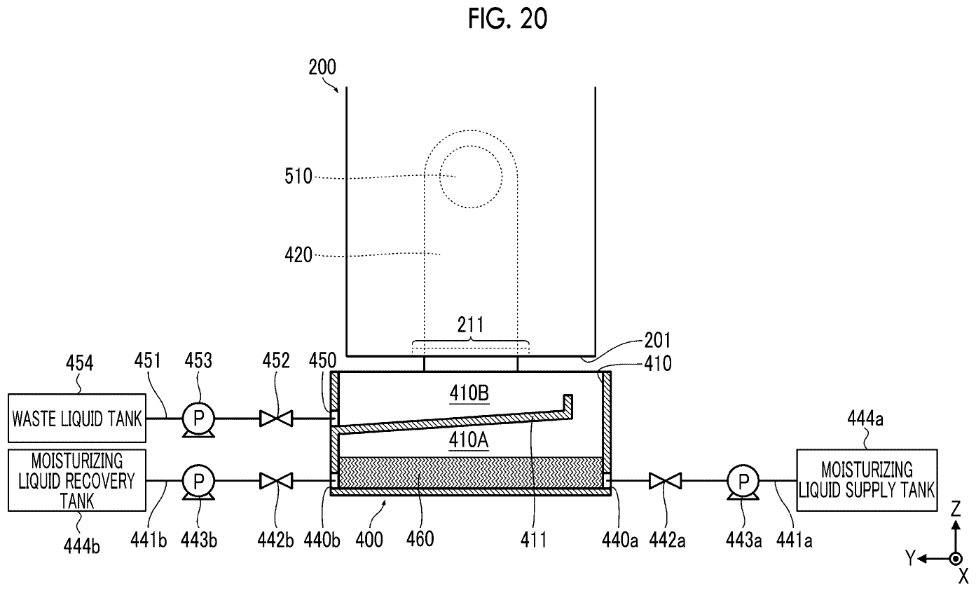

FIG. 20 is a view showing a second modification example of the cap. FIG. 20 shows a cross-sectional shape of the cap 400 in a cross section orthogonal to the swing shaft.

As shown in FIG. 20, the cap 400 of the present example comprises a partition plate 411 inside (inside of the recess portion 410), and the inside is divided into two parts in the depth direction. A space on a side of the bottom portion with the partition plate 411 interposed therebetween is referred to as a first space 410A, and a space on a side of the opening portion is referred to as a second space 410B. The first space 410A and the second space 410B communicate with each other at one end (right end in FIG. 20) of the partition plate 411.

The first space 410A is used as a space for storing a liquid (moisturizing liquid) for moisturizing. On the other hand, the second space 410B is used as a space for collecting the ink jetted or discharged from the nozzle 212.

The first space 410A is provided with a supply port 440a and a recovery port 440b for the moisturizing liquid 460.

A moisturizing liquid supply pipe 441a is connected to the supply port 440a. The moisturizing liquid supply pipe 441a is connected to a moisturizing liquid supply tank 444a via a moisturizing liquid supply valve 442a and a moisturizing liquid supply pump 443a. A moisturizing liquid that is not used is stored in the moisturizing liquid supply tank 444a. By opening the moisturizing liquid supply valve 442a and driving the moisturizing liquid supply pump 443a, the moisturizing liquid stored in the moisturizing liquid supply tank 444a is supplied to the first space 410A.

A moisturizing liquid recovery pipe 441b is connected to the recovery port 440b. The moisturizing liquid recovery pipe 441b is connected to a moisturizing liquid recovery tank 444b via a moisturizing liquid recovery valve 442b and a moisturizing liquid recovery pump 443b. The used moisturizing liquid is stored in the moisturizing liquid recovery tank 444b. By opening the moisturizing liquid recovery valve 442b and driving the moisturizing liquid recovery pump 443b, the moisturizing liquid stored in the first space 410A is recovered in the moisturizing liquid recovery tank 444b.

The second space 410B is provided with a liquid discharging port 450. A liquid discharging pipe 451 is connected to the liquid discharging port 450. The liquid discharging pipe 451 is connected to a waste liquid tank 454 via a liquid discharging valve 452 and a liquid discharging pump 453. The waste liquid tank 454 stores the ink recovered in the second space 410B. By opening the liquid discharging valve 452 and driving the liquid discharging pump 453, the ink recovered in the second space 410B is recovered in the waste liquid tank 454.

The ink is recovered in a state in which the cap 400 is closed (capped state). That is, the operation is performed at the closed position. As shown in FIG. 20, the partition plate 411 is disposed to be inclined toward the liquid discharging port 450 in the closed position. More specifically, the liquid drain pipe 440 is disposed to be inclined from a horizontal state such that the liquid discharging port 450 side is lower. Accordingly, the recovered ink can be naturally guided to the liquid discharging port 450 by using gravity.

In a case of moisturizing the nozzle surface 210, the moisturizing liquid 460 is stored in the first space 410A of the cap 400. The moisturizing liquid 460 opens the moisturizing liquid supply valve 442a and drives the moisturizing liquid supply pump 443a. As a result, the moisturizing liquid is supplied from the moisturizing liquid supply tank 444a to the first space 410A. After a certain amount of the moisturizing liquid is supplied, the driving of the moisturizing liquid supply pump 443a is stopped, and the moisturizing liquid supply valve 442a is closed. As a result, the moisturizing liquid 460 is stored in the first space 410A. By storing the moisturizing liquid 460 in the first space 410A, the inside of the recess portion 410 is moistened, and the nozzle surface 210 is moisturized.

In a case of recovering the moisturizing liquid 460, the moisturizing liquid recovery valve 442b is opened, and the moisturizing liquid recovery pump 443b is driven. As a result, the moisturizing liquid 460 is recovered from the first space 410A via the recovery port 440b. The recovered moisturizing liquid is stored in the moisturizing liquid recovery tank 444b.

In a case of purging or preliminary jetting, the purging or preliminary jetting is performed in a state where the cap 400 is positioned at the closed position. The ink discharged or jetted from the nozzle 212 by purging or preliminary jetting is recovered by the partition plate 411 and stored in the second space 410B.

In a case of recovering the ink stored in the second space 410B, the liquid discharging valve 452 is opened, and the liquid discharging pump 453 is driven. Accordingly, the ink is recovered from the second space 410B via the liquid discharging port 450. The recovered ink is stored in the waste liquid tank 454.

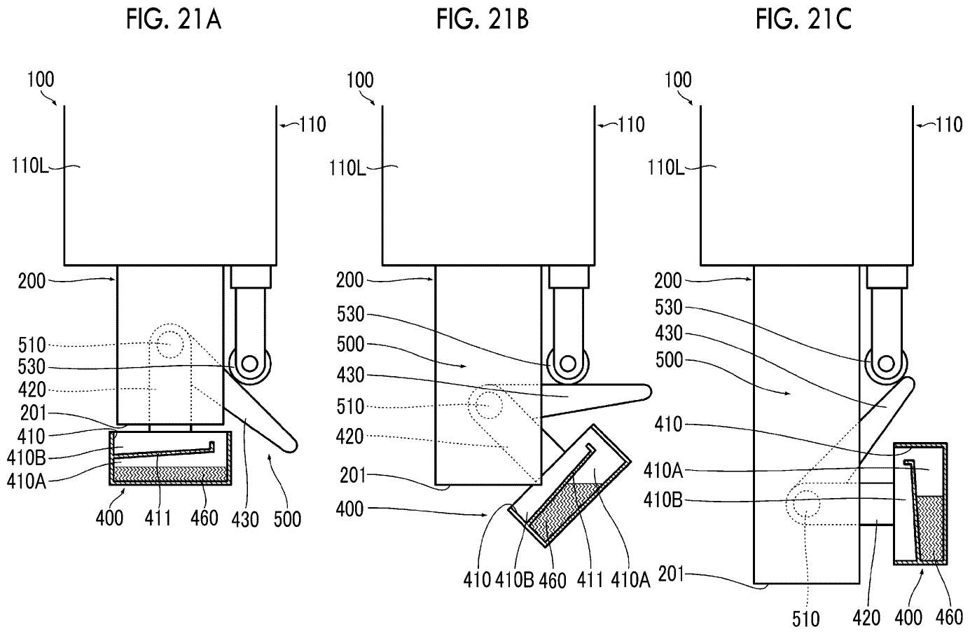

FIGS. 21A to 21C are diagrams showing a change in the state of the moisturizing liquid due to the swinging of the cap.

FIG. 21A shows a state in which the cap 400 is positioned at the closed position. FIG. 21C shows a state in which the cap 400 is positioned at the open position. FIG. 21B shows a state in which the cap 400 is positioned between the closed position and the open position.

As shown in FIGS. 21A to 21C, in a case where the cap 400 is swung from the closed position toward the open position, the cap 400 is gradually inclined from the horizontal state. In a case where the cap 400 is tilted, the moisturizing liquid 460 stored in the recess portion 410 tends to flow out of the opening of the recess portion 410. However, since the cap 400 of the present example comprises the partition plate 411 in the recess portion 410, the outflow of the moisturizing liquid 460 is dammed by the partition plate 411. Therefore, as shown in FIGS. 21B and 21C, even in a case where the cap 400 is inclined or erected, the moisturizing liquid 460 can be held in the recess portion 410. In the present modification example, the partition plate 411 is an example of a dam portion.

As described above, according to the cap 400 of the present example, even in a case where the cap 400 is swung for opening and closing, the moisturizing liquid 460 can be held in the recess portion 410. In addition, the ink discharged or jetted from the nozzle 212 can be recovered without being mixed with the moisturizing liquid 460.

### (3) Third Modification Example of Cap

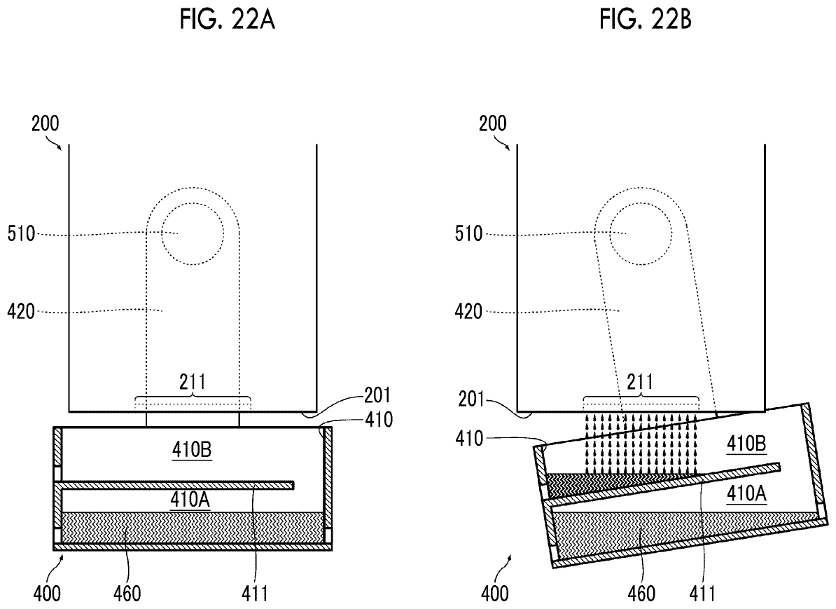

FIGS. 22A and 22B are diagrams showing a third modification example of the cap.

FIGS. 22A and 22B show a modification example of the cap 400 comprising the partition plate 411. FIG. 22A shows a state of the cap 400 during capping. FIG. 22B shows a state of the cap 400 during purging.

As shown in FIG. 22A, the cap 400 of the present example is different from the cap 400 shown in FIG. 20 in that the partition plate 411 is disposed horizontally in the closed position.

In the closed position, since the partition plate 411 is disposed horizontally, in a case where the ink is jetted or discharged from the nozzle 212 during capping, there is a concern that the ink received by the partition plate 411 flows into the first space 410A.

Therefore, as shown in FIG. 22B, in a case of purging or preliminarily discharging with the cap 400 of the present example, the cap 400 is tilted. Accordingly, the ink jetted or discharged from the nozzle 212 can be recovered without being mixed with the moisturizing liquid 460.

In the present modification example as well, the partition plate 411 has a function of damming the moisturizing liquid 460 stored in the recess portion 410. Therefore, even in the present modification example, the partition plate 411 functions as a dam portion.

### (4) Other Modification Examples of Cap

In the above-described example, the configuration is adopted in which the moisturizing liquid is supplied to and recovered from the cap 400 by using the pump, but a configuration may be adopted in which the moisturizing liquid is supplied to and recovered from the cap 400 by using gravity. In this case, for example, the moisturizing liquid supply tank 444a is installed at a position higher than the cap 400, and the moisturizing liquid recovery tank 444b is installed at a position lower than the cap 400. The same applies to the ink recovered by purging or the like, and a configuration may be adopted in which the ink is recovered using gravity.

In a case where the moisturizing liquid is used, a liquid absorbing body may be provided in the recess portion 410. Accordingly, the moisturizing liquid can be efficiently held in the recess portion 410. In addition, in a case where the cap 400 is swung, it is possible to suppress the moisturizing liquid from flowing out of the opening portion.

In a case where the partition plate 411 is disposed in the recess portion 410, the liquid absorbing body may be disposed in both the first space 410A and the second space 410B.

As the liquid absorbing body, for example, a porous body such as a sponge can be adopted.

### Second Embodiment

In a case of a configuration in which the cap is swung to open and close, it is necessary to design the cap to be swung not to come into contact with the print head. In order to avoid contact between the cap and the print head, it is necessary to ensure a clearance between the cap and the print head. However, in a case where the clearance is large, a large gap is generated between the cap and the print head during capping, and the sealing effect of the cap is reduced. In the present embodiment, a print head unit in which a sealing effect by a cap can be improved will be described.

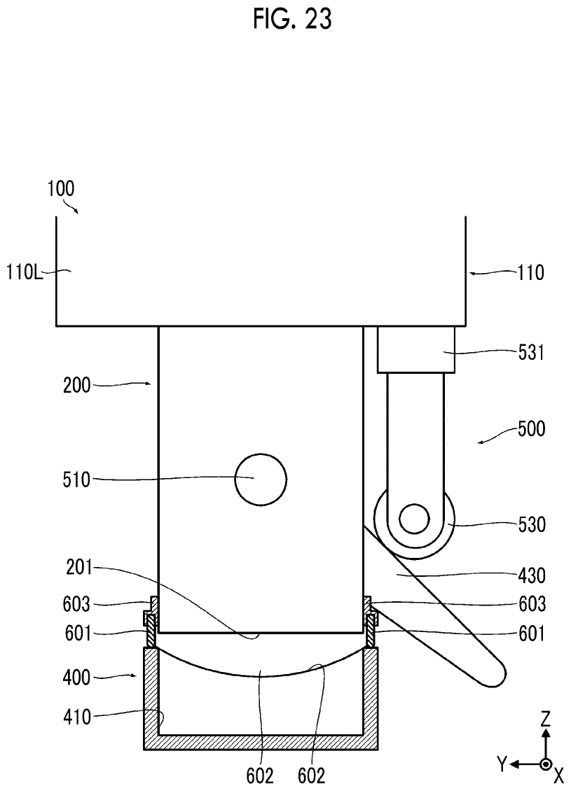

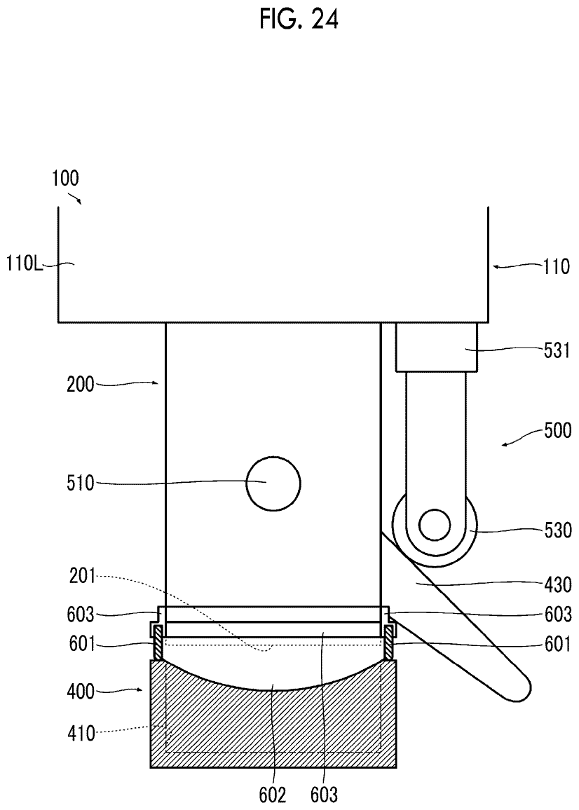

FIGS. 23 and 24 are diagrams showing configurations of main portions of the print head unit. FIG. 23 shows a partial cross section of the print head 200 at an intermediate position in the longitudinal direction. FIG. 24 shows a partial cross section at one end of the print head 200 in the longitudinal direction.

As shown in FIGS. 23 and 24, the print head unit 100 of the present embodiment includes a seal 600 that is elastically deformable with respect to the print head 200. The configuration other than the seal 600 is the same as that of the print head unit 100 of the first embodiment. Therefore, in the following description, only the configuration and the effects of the seal 600 will be described.

The seal 600 is provided along the peripheral edge of the tip of the print head 200. The seal 600 is configured by front and rear sealing portions 601 provided along front and rear edges (upstream and downstream edges in the paper transport direction) of the print head 200 and both ends sealing portion 602 provided at both ends of the print head 200 in the longitudinal direction. The front and rear sealing portion 601 has a linear shape at the distal end. The both ends sealing portion 602 has a shape of which a distal end has an arc shape. The distal ends of the both ends sealing portion 602 constitute a part of a circle centered on the rod 510. The front and rear sealing portions 601 and the both ends sealing portion 602 are attached to the print head 200 via a holder 603.

In a case where the cap 400 is positioned at the closed position, the front and rear sealing portion 601 and the both ends sealing portion 602 are pressed and abutted against the peripheral edge of the opening portion of the cap 400 by the distal end portion. Specifically, as shown in FIG. 23, the front and rear sealing portion 601 is pressed and abutted against peripheral edge portions (upstream and downstream peripheral edge portions in the paper transport direction) of the opening portion of the cap 400. In addition, as shown in FIG. 24, the both ends sealing portion 602 is pressed and abutted against peripheral edge portions of both ends of the cap 400 in the longitudinal direction. A portion (peripheral edge portions at both ends of the recess portion 410 in the longitudinal direction) of the cap 400 that is abutted by the both ends sealing portion 602 has an arc shape corresponding to the shape of the tip of the both ends sealing portion 602.

With the print head unit 100 of the present embodiment configured as described above, in a case where the cap 400 is positioned at the closed position, the front and rear sealing portions 601 and the both ends sealing portion 602 is pressed and abutted against the peripheral edge of the opening portion of the cap 400. As a result, the periphery of the opening portion is sealed with the seal 600. Since the seal 600 is elastically deformable, the movement of the cap 400 is not hindered even in a case where the seal 600 comes into contact with the cap 400.

As described above, according to the print head unit 100 of the present embodiment, it is possible to improve the sealing property during capping while ensuring the clearance required for opening and closing the cap 400.

In the above-described embodiment, the configuration is adopted in which the seal 600 is provided on the print head side, but a configuration may be adopted in which the seal is provided on the cap side.

In addition, in the above-described embodiment, the configuration is adopted in which the entire circumference of the print head 200 is sealed, but a configuration may be adopted in which only the front and rear directions are sealed. In this case, it is preferable that the clearance is set to be as small as possible at both ends in the longitudinal direction.

The material of the seal 600 is not particularly limited. It suffices that the material is a material that is elastically deformable and can ensure the sealing property. In the present embodiment, the seal 600 is an example of a sealing member.

### Third Embodiment

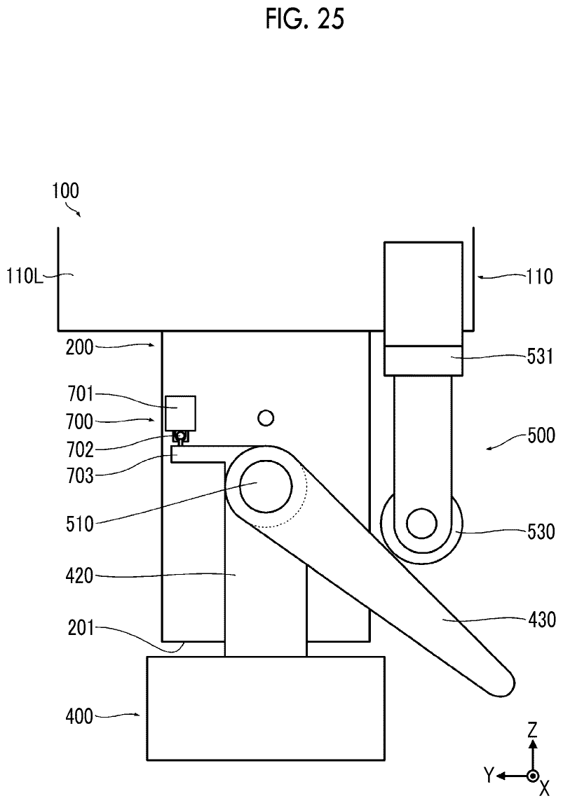

FIG. 25 is a view showing a configuration of a main portion of a third embodiment of the print head unit.

The print head unit of the present embodiment includes a locking mechanism that locks the cap at the closed position. The print head unit is the same as the print head unit 100 of the first embodiment except that the print head unit includes a locking mechanism. Therefore, only the configuration and the effects of the locking mechanism will be described below.

In the present embodiment, the locking mechanism is configured by a push latch mechanism using the push latch 700. The push latch mechanism is a latch mechanism in which locking and unlocking are performed by a pushing operation. As shown in FIG. 25, the push latch 700 is configured by a push latch body 701 and a strike 702. The push latch 700 is coupled (locked) by an operation of pushing the strike 702 into the push latch body 701, and the coupling is released (unlocked) by an operation of further pushing.

The push latch body 701 is provided on both side surfaces of the print head 200 in the longitudinal direction (only one side surface is shown in FIG. 25).

On the other hand, the strike 702 is integrally attached to the arm portion 420 of the cap 400 via a bracket 703. Therefore, in a case where the cap 400 swings, the strike 702 swings integrally with the cap 400.

FIG. 25 shows a state in which the cap 400 is positioned at the closed position. As shown in FIG. 25, the push latch body 701 and the cap 400 are disposed in a positional relationship in which the push latch body 701 and the cap 400 engage with each other in a case where the cap 400 is positioned at the closed position.

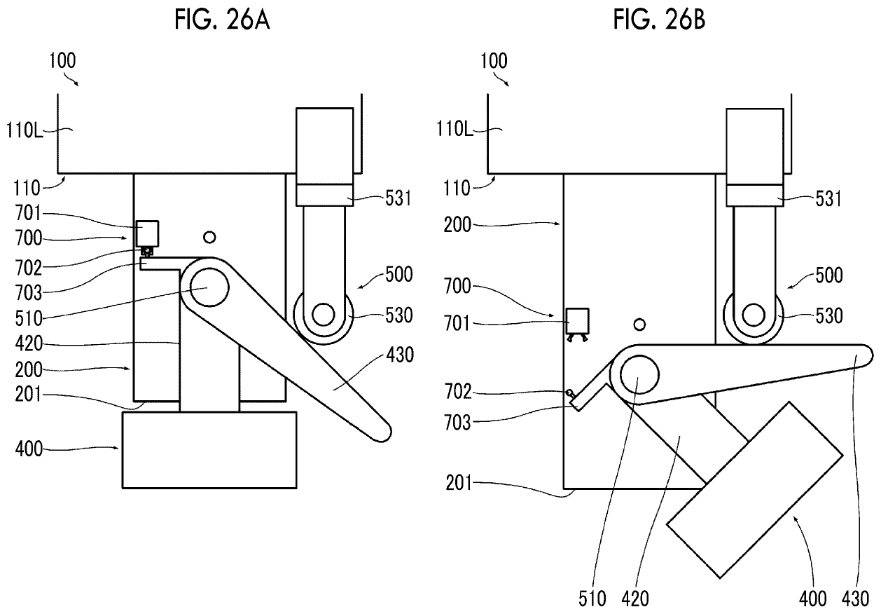

FIGS. 26A and 26B are explanatory views of locking and unlocking operations of the cap using the push latch mechanism. FIG. 26A is a view showing a state in which the cap is locked. FIG. 26B is a view showing a state in which the cap is unlocked.

As shown in FIG. 26A, in the cap 400 at the closed position, the strike 702 is engaged with the push latch body 701. The strike 702 is engaged with the push latch body 701, so that the swing of the cap 400 is locked and held at the closed position.

The capping state is maintained even in a case where the lever 430 is separated from the contactor 530 by being locked by the push latch 700. Therefore, even in a case where the print head 200 is lowered after the locking, the locked state is maintained.

In a case of unlocking, the cap 400 is swung to push the strike 702 toward the push latch body 701. In the example shown in FIGS. 26A and 26B, the cap 400 swings in a clockwise direction. The cap 400 swings in a clockwise direction by ascending the print head 200. Therefore, in a case where the lock is released, the print head 200 is ascended by a predetermined amount (the amount necessary for the lock to be released). Accordingly, the strike 702 is pushed into the push latch body 701, and the engagement between the strike 702 and the push latch body 701 is released.

By the disengagement of the strike 702 and the push latch body 701, the lock of the cap 400 is released, and the cap 400 can swing. As a result, as shown in FIG. 26B, the cap 400 swings in conjunction with the descent of the print head 200.

As described above, with the print head unit 100 of the present embodiment, the cap 400 can be held in the closed position regardless of the position of the print head 200. That is, the capping state can be maintained. As a result, the capping state can be stably maintained.

In the present embodiment, the push latch mechanism is employed as the locking mechanism, but the locking mechanism is not limited thereto. A mechanism that can lock the cap 400 at a constant position with respect to the print head 200 may be used.

In addition, in the above-described embodiment, the cap 400 is adapted to be lockable only at the closed position, but may be adapted to be lockable even at the open position.

In addition, the print head unit of the embodiment described above does not comprise a seal, but the locking mechanism can also be employed in the print head unit comprising a seal. By employing the locking mechanism in the print head unit comprising the seal, the seal can be reliably adhered, and the sealing property by the seal can be improved.

### OTHER EMBODIMENTS

### Movement Form of Cap

In the above-described embodiment, the cap 400 is configured to swing (arc motion) along a circle centered on the rod 510, but the movement form of the cap is not limited thereto.

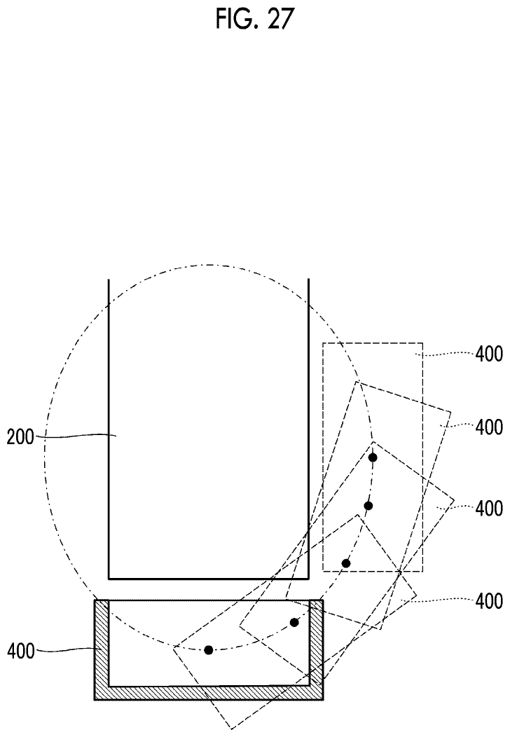

FIG. 27 is a diagram showing another example of the movement form of the cap.

FIG. 27 shows an example of a case where the cap 400 swings along an elliptical movement locus. In this way, by swinging the cap 400 along the elliptical movement locus, the cap 400 can be held close to the print head 200 at the open position. Accordingly, the print head unit can be reduced in size.

In addition, the cap 400 may be configured to linearly move along the nozzle surface in the transport direction of the paper P, and open and close.

In addition, in the above-described embodiment, the cap is configured to be erected at the open position, but the cap may be configured to be moved to the open position while maintaining the horizontal state.

### Mechanism for Moving Cap

A mechanism that causes the cap to perform a desired operation by using the movement of the print head can be realized by a cam mechanism, a gear mechanism, a link mechanism, or the like alone or in an appropriate combination.

In addition, in the above-described embodiment, the configuration is adopted in which the print head 200 is elevated by electric power using the elevating drive motor 325, but the print head 200 may be manually elevated.

### Ink Jet Recording Device

In the above-described embodiment, a case where the present invention is applied to an ink jet printer has been described as an example, but the application of the present invention is not limited thereto. The present invention can be applied to all devices (ink jet recording devices) that record an image on a medium by an ink jet method. In addition, the medium is not limited to paper, and various materials are included.

In addition, in the embodiment described above, the case where the paper (medium) is transported by the belt has been described as an example, but the form of transporting the paper is not limited thereto. For example, the present invention can also be applied to an ink jet recording device in which paper is transported by a drum. In an ink jet recording device in which paper is transported by a drum, a print head may be disposed at an inclination. In this case, by disposing the partition plate in the recess portion of the cap, the moisturizing liquid can be retained in the cap (see FIG. 20).

In addition, in the above-described embodiment, the case of printing on sheet paper has been described as an example, but the present invention can be similarly applied to an ink jet printer that prints on roll paper.

Further, in the above-described embodiment, a case where the present invention is applied to a so-called single-pass type ink jet recording device has been described as an example, but the application of the present invention is not limited thereto. The ink jet recording method can also be applied to a so-called shuttle type ink jet recording device. Since the recording head is longer in the single-pass type ink jet recording device than in a shuttle type ink jet recording device, the present invention in which the cap mechanism can be encompassed in the head unit is particularly effective. That is, in an ink jet recording device having a configuration in which the cap mechanism is not included in the head unit, a mechanism for transporting the head unit to a space for the cap and a position of the cap is separately required. Since a space for the cap is required for the length of the print head, the single-pass type ink jet recording device tends to be large. By encapsulating the cap mechanism in the head unit, even in the single-pass type ink jet recording device, the size of the device can be reduced. Therefore, the present invention is particularly effective in a single-pass type ink jet recording device.

In addition, in the embodiment described above, the recording head is modularized, and a plurality of head modules are connected to each other to generate one recording head, but the configuration of the recording head is not limited thereto. A single recording head that is not modularized can also be adopted.

### EXPLANATION OF REFERENCES

1: ink jet printer
10: paper transport unit
11: belt
12: roller
12A: driving roller
13: belt drive motor
15: suction unit
20: printing unit
30: image reading unit
31: image reading device
100: print head unit
100Bk: print head unit
100C: print head unit
100M: print head unit
100Y: print head unit
110: base frame
110L: side wall portion
110R: side wall portion
110T: top surface portion
200: print head
200Bk: print head
200C: print head
200M: print head
200Y: print head
201: head module
210: nozzle surface
211: nozzle region
212: nozzle
300: print head elevating mechanism
310: support portion
311L: guide rail
311R: guide rail
312L: slider
312R: slider
320: driving unit
321: screw shaft
322: bracket
323: bracket
324: bearing
325: elevating drive motor
326: nut
327: connection bar
400: cap
410: recess portion
410A: first space
410B: second space
411: partition plate
420: arm portion
421: mounting hole
430: lever
431: shaft portion
440a: supply port
440b: recovery port
441a: moisturizing liquid supply pipe
441b: moisturizing liquid recovery pipe
442a: moisturizing liquid supply valve
442b: moisturizing liquid recovery valve
443a: moisturizing liquid supply pump
443b: moisturizing liquid recovery pump
444a: moisturizing liquid supply tank
444b: moisturizing liquid recovery tank
450: liquid discharging port
451: liquid discharging pipe
452: liquid discharging valve
453: liquid discharging pump
454: waste liquid tank
460: moisturizing liquid
500: cap opening and closing mechanism
510: rod
511: spring
512: spring hook portion
513: spring hook portion
520: stopper pin
530: contactor
531: bracket
540: pinion
541: rack
542: bracket
551: first joint
552: first link
553: second joint
554: second link
561: plate cam
562: bracket
563: lever
564: shaft portion
565: contactor
600: seal
601: front and rear sealing portion
602: both ends sealing portion
603: holder
700: push latch
701: push latch body
702: strike
703: bracket
P: paper

What is claimed is:

1. A head unit comprising:
a recording head that has a nozzle surface on which a plurality of nozzles are disposed and is movable between a first position and a second position;
a cap that is provided on the recording head and is movable between a third position that covers the nozzle surface and a fourth position that opens the nozzle surface; and
an interlocking mechanism that moves the cap from the third position to the fourth position by an operation of moving the recording head from the first position to the second position and moves the cap from the fourth position to the third position by an operation of moving the recording head from the second position to the first position.

2. The head unit according to claim 1,
wherein the recording head moves between the first position and the second position by linear motion,
the cap moves between the third position and the fourth position by arc motion, and the interlocking mechanism converts the linear motion of the recording head into the arc motion of the cap.

3. The head unit according to claim 2,
wherein the interlocking mechanism includes
a biasing member that biases the cap toward the fourth position, and
an engaging member that engages with the cap at a constant position with respect to the recording head that moves from the second position to the first position and moves the cap from the fourth position to the third position against a biasing force of the biasing member.

4. The head unit according to claim 2,
wherein the interlocking mechanism includes
a biasing member that biases the cap toward the third position, and
an engaging member that engages with the cap at a constant position with respect to the recording head that moves from the first position to the second position and moves the cap from the third position to the fourth position against a biasing force of the biasing member.

5. The head unit according to claim 2,
wherein the interlocking mechanism is configured by a combination of gears including a rack and a pinion.

6. The head unit according to claim 2,
wherein the interlocking mechanism is configured by a cam mechanism or a link mechanism that converts linear motion into arc motion.

7. The head unit according to claim 1,
wherein the cap has a hollow shape that is open, and an opening portion is disposed to face the nozzle surface at the third position.

8. The head unit according to claim 7, further comprising
a sealing member that is provided on the recording head or the cap and that seals a periphery of the opening portion between the cap and the recording head positioned at the third position.

9. The head unit according to claim 8, further comprising
a locking mechanism that locks the cap positioned at the third position.

10. The head unit according to claim 9,
wherein the locking mechanism is configured by a push latch mechanism.

11. The head unit according to claim 7,
wherein the cap includes a liquid absorbing body inside.

12. The head unit according to claim 7,
wherein the cap includes a dam portion that dam a liquid stored inside the cap from flowing out of the opening portion in a case where the cap is tilted.

13. The head unit according to claim 12,
wherein the cap is divided into two parts in a depth direction by the dam portion,
a liquid for moisturizing is stored in a space on a side of a bottom portion with the dam portion interposed therebetween, and
a liquid jetted or discharged from the nozzle in a space on a side of the opening portion with the dam portion interposed therebetween is recovered.

14. The head unit according to claim 1,
wherein the cap moves between the third position and the fourth position by arc motion about an axis parallel to an arrangement direction of the nozzle, and
in a cross section orthogonal to the axis, a portion of the cap closest to the axis is an edge portion of the cap.

15. The head unit according to claim 1, further comprising
a driving unit that moves the recording head between the first position and the second position.

16. An ink jet recording device comprising:
a transport unit that transports a medium; and
the head unit according to claim 1 that records an image on the medium by jetting an ink from the nozzle toward the medium transported by the transport unit.

17. The ink jet recording device according to claim 16,
wherein the head unit records the image on the medium in a single pass.
